(19) United States
(12) Patent Application Publication
(10) Pub. No.: US 2015/0302310 A1
(43) Pub. Date: Oct. 22, 2015

(54) METHODS FOR DATA COLLECTION AND ANALYSIS FOR EVENT DETECTION

(71) Applicant: Nordic Technology Group, Providence, RI (US)

(72) Inventors: Erik Wernevi, Providence, RI (US); Joshua Napoli, Providence, RI (US); Sheldon Apsell, Chestnut Hill, MA (US)

(21) Appl. No.: 14/569,063

(22) Filed: Dec. 12, 2014

Related U.S. Application Data
(63) Continuation-in-part of application No. 13/840,155, filed on Mar. 15, 2013.
(60) Provisional application No. 61/916,051, filed on Dec. 13, 2013.
(60) Provisional application No. 61/916,128, filed on Dec. 13, 2013.
(60) Provisional application No. 61/916,130, filed on Dec. 13, 2013.
(60) Provisional application No. 61/916,131, filed on Dec. 13, 2013.
(60) Provisional application No. 61/916,132, filed on Dec. 13, 2013.
(60) Provisional application No. 61/916,133, filed on Dec. 13, 2013.
(60) Provisional application No. 61/916,135, filed on Dec. 13, 2013.

(51) Int. Cl. G06N 5/04; G06N 99/00

(52) U.S. Cl. CPC G06N 5/047; G06N 99/005

(57) ABSTRACT

Behavior modeling includes how to detect and/or predict events based on observed changes in behavior. Detection of behavior that indicates possible adverse health events is performed by remote observation of a person's behavior. Captured data is correlated with an appropriate person, without identifying the person. People are associated with objects/locations, in the environment based on how the people relate to those objects/locations. Thus, people are identified based on their body characteristics or movement. Person specific data captured is labeled with unique identifiers. The location of certain objects/locations is correlated with the behavior profile to capture and analyze a nested pattern within a larger behavior pattern. Next to certain objects, certain types of behaviors/movements are expected. However, if the movement at a determined point in time deviates significantly from “normal” behavior patterns, such deviation may be an indication that something is wrong.

### CROSS-REFERENCE TO RELATED APPLICATION

This application is a continuation-in-part of application Ser. No. 13/840,155, filed Mar. 15, 2013, provisional application Ser. No. 61/916,051, filed Dec. 13, 2013, provisional application Ser. No. 61/916,128, filed Dec. 13, 2013, provisional application Ser. No. 61/916,130, filed Dec. 13, 2013, provisional application Ser. No. 61/916,131, filed Dec. 13, 2013, provisional application Ser. No. 61/916,132, filed Dec. 13, 2013, provisional application Ser. No. 61/916,133, filed Dec. 13, 2013, provisional application Ser. No. 61/916,135, filed Dec. 13, 2013, the contents of which are incorporated herein by reference in their entirety.

### BACKGROUND

The present technology relates to the field of behavior modeling and how to detect, or predict, an occurrence of adverse events based on observed changes in a behavior.

Elderly people suffer from a number of age-related health problems. These include, but are not limited to, diminished visual acuity, difficulty with hearing, impairment of tactile senses, short and long term memory loss, lack of stability resulting in frequent falls, and other chronic conditions. All of these problems result in serious concerns regarding the safety of elderly people living at home, particularly when living alone. Many studies have shown the benefits of getting help quickly after certain types of adverse events such as a fall or stroke. For example, in the case of falls, getting help within one hour is widely believed to substantially reduce risk of both hospitalization and death.

For a long time, there have been numerous attempts to address these long-standing problems related to elder care by technological means. Early monitoring systems employed a pendent or wristband worn by the person being monitored that contained a medical alarm button. When the wearer pressed the button on the pendent, the pendant sent a signal to a base station connected to a call center by means of the public telephone network.

Devices to detect unusual behaviors, including behaviors that may be hazardous or indicate a bad outcome of some condition, continued to evolve. Wearable sensors were added to detect falling events, for example. Some systems include sensors to detect vital signs such as pulse, heartbeat, and temperature.

Another approach is using passive sensors in the home to detect critical events. Using this approach does not require active participation by the user. The person monitored is simply free to go about their daily activities without having to change their routines. Other approaches detect isolated acts or behavior patterns through the use of motion sensors and/or sensors linked to different articles in the household such as light switches, door locks, toilets etc. Another technique for passive sensing is to use cameras and different methods for recognizing patterns of behavior.

U.S. Pat. No. 6,095,985 describes a known system that directly monitors the health of a patient as opposed to indirectly, or behaviorally, detecting a medical problem. Rather, a set of physiological sensors are placed on the patient's body.

A number of patents, such as U.S. Pat. Nos.: 7,586,418; 7,589,637; and 7,905,832 merely monitor activity, as an attribute having a binary value, during various times of day. The assumption is that if the patient is in motion during appropriate times of the day and not in motion during the night, then no medical problem exists. In such systems, if the patient takes a nap during the day or gets up to go to the bathroom at night, a false alarm will be generated. Another patent, U.S. Pat. No. 8,223,011, describes a system wherein for each patient predetermined rules are established for each daily block of time and place within the residence. All of the patents referred to above require some a priori knowledge of the patient, the patient's habits, and/or the patient's environment, either for determining individual habits or for setting detection and/or significance thresholds for sensors or processed sensor outputs.

A number of other systems described in US patents add some degree of adaptive learning to help construct a behavior profile. For example, U.S. Pat. No. 7,552,030 describes an adaptive learning method to generate a behavior model. The method is shown to generate specific individual behavior models for specific predetermined actions such as opening a refrigerator door. Another patent, U.S. Pat. No. 7,847,682 describes a system that senses abnormal signs from a daily activity sequence by using a preset sequence alignment algorithm and comparing a sequence alignment value obtained by the system with a threshold value. Other systems described in US patents, such as those described in U.S. Pat. Nos. 7,202,791 and 7,369,680, employ video cameras to generate a graphic image from which feature extraction algorithms are employed to use as a basis for building up a behavior profile. The systems and methods described define vertical distance, horizontal distance, time, body posture and magnitude of body motion as the features to be extracted from the video image.

### SUMMARY

In view of the above, a need exists for systems and methods that perform behavior modeling and how to detect, or predict, an occurrence of adverse events securely, efficiently and in a practical manner without intrusion. In many situations, it is undesirable to use video cameras, or other equipment that capture personal identifying information, for reasons of privacy and user preferences. For example, many bed exit detectors are not able to predict whether a person's motion indicates an intention to exit the bed. For fall prone people, prediction of bed exit intention is helpful for alerting caregivers to attend to the person to avoid injury from an accidental fall.

The subject technology includes an effective approach to monitoring safety of the elderly. The subject technology can detect a broad range of current health problems or potential future health problems. The subject technology can detect behaviors that are indicators for possible health risks or adverse health events. These indicators can be detected by remote observation of elements of a person's behavior.

In one embodiment, the subject technology correlates captured data from the location of certain objects, or locations, with an appropriate person, without identifying the person. The subject technology correlates the location of certain objects or locations with the behavior profile to capture and analyze “nested behaviors” e.g. a behavior pattern within a larger behavior pattern. The subject technology determines conditions under which a received reading correspond to the occurrence of an event that may indicate a health risk.

An exemplary embodiment of the subject technology includes aspects to associate people that spend time in an environment with objects, or locations, in the environment based on how the people relate to those objects, or locations. Data captured about the people are labeled with unique identifiers to help further study. Embodiments of the technology can be applied to data capture methods so as to enable the correlation of data captured with the appropriate person. Preferably, the method is 1) automatic (does not require manual labor), 2) can deal with environments where multiple people are present, and 3) does not require that data is associated with a person name or other personal ID (in order to increase privacy and eliminate ID errors).

Another exemplary embodiment of the present technology includes aspects to identify people that spend time in an environment based on their relative body characteristics (e.g., height, shape, etc.) or way of moving (e.g., gait, posture, etc.). Data captured about the people are labeled with unique identifiers to help further study. Embodiments of the present technology can be applied to data capture methods so as to enable the correlation of data captured with the appropriate person.

Another exemplary embodiment of the present technology correlates the location of certain objects, or locations, with the behavior profile to capture and analyze “nested behaviors” e.g., a behavior pattern within a larger behavior pattern. Next to certain objects, certain types of behaviors and/or movements are expected, independent of the time of day. Example of such objects are the bed, water faucet, dining room table, toilet, refrigerator, stove, medicine bottle or cabinet and the like. If the movement at a determined point in time deviates significantly from previously recorded behavior patterns, the deviation may be an indication that something is wrong and should be checked. The objects don't necessarily need to be known in advance. The objects can be determined based on these “nested behaviors”. The present technology helps constrain what is to be monitored and aids studies of how something is being done, not just if it is done, or not done.

According to embodiments of the present technology, a system monitors activity of a person to obtain measurements of temporal and spatial movement parameters of the person relative to an object for use in health risk assessment and health alerts.

According to an exemplary variation of embodiments of the present technology, the system may perform a foreground/background segmentation step that uses an optical sensor. A model of the background is stored in a memory by a processor of a computer. The background model may be adapted, as stationary objects are occasionally moved, introduced or removed from the field of view.

Another exemplary embodiment of the present technology includes aspects to determine a pattern, or absence of pattern, of behavior, in how an activity is performed by a person. Changes to the pattern that can be detected, or variations to some small detail in the pattern may indicate the occurrence of, or imminent occurrence of, an event. According to one aspect of an embodiment of the present technology, a sequence of deviations in how an activity, or activities, are performed by a person are assessed based on observed movements of one or more body parts (or even the whole body). A determination is made, based upon detection of a deviation from the normal pattern, that an adverse event has occurred, or is likely to occur, and an appropriate response for assistance or further investigation is triggered.

In accordance with some aspects of embodiments of the present technology, the behavior of the user is captured through sequential observation of one or more body parts of the user based on some combination of horizontal location, vertical height, orientation, velocity, and time of observation of the one or more body parts. The observed data is used to continuously create and update a behavior profile against which future observations are compared. Correlation is used to determine a pattern of behavior for the one or more body parts. Events are detected, or possible future events predicted, by detecting changes in the observed pattern. Significant changes in behavior are indicated through lack of correlation, either in the overall behavior pattern, or in some detail of the behavior pattern.

For example, the pattern may be formed from the observations of a daily walk from the bedroom to the kitchen. A deviation may be indicated by observations resulting from the omission of the walk, or a deviation may be indicated by observations resulting from a limp detected in one leg. At any time, if a minimum set of data is determined to deviate, in a pattern that is inconsistent with past observed data and, or, recorded past behavior profile, further data is collected to determine if the condition signifies an abnormal event that requires that an alert be issued.

The observed deviation from normal behavior may not correlate to a health condition with readily observable symptoms. But the observed deviation may, in fact, correlate to the initial stages of a health problem that in the future will show readily detectable symptoms. Medical personnel should therefore further investigate deviations from normal behavior.

An exemplary embodiment of the present technology uses no a priori information about the user and can with a sufficient number of past observations determine if an adverse event has occurred or if it is likely to occur in the future, and issue an appropriate response for assistance or further investigation.

While there are numerous advantages to the present technology, several advantages include: 1. The methods do not require any active participation by the person being monitored; 2. The methods do not require any a priori knowledge of the person or the person's environment; 3. The methods do not require knowledge of the cause of the problem; 4. The methods are effective over a broad range of medical or health initiated problems; 5. The methods do not require that the name of a person or other personal identifying information is known and works even if multiple people spend time in the environment; and 6. The methods work even in situations where a person only spends limited time in the environment that is being monitored.

In view of the above, a number of limitations associated with conventional systems and methods are overcome by the foregoing as well as other advantages of aspects of embodiments of the present technology. Some such limitations are that medical alarm button systems depend upon the active participation of the wearer. If the wearer does not recognize that assistance was required or if the wearer is not conscious, no help will be summoned. Other, similar systems exhibit the same limitation.

Further, wearable sensors suffer from limitations arising from failures of patient compliance. To be effective in providing continuous safety monitoring, the sensors must be worn continuously. With wearable sensors, there is also a general trade-off between ease of wearing and accuracy. For example, a movement sensor worn around the torso often has a higher specificity and sensitivity than a sensor worn around the wrist or the neck; however, this is at the expense of wearability. In practice, wearable sensors have proven to be very unreliable. As a result, these alarms are often ignored.

Vital sign sensors frequently suffer from the same limitation as other wearable sensors of lack of patient compliance and, moreover, vital sign sensors are typically best suited to address specific conditions. Passive sensor systems deployed in homes are designed to detect specific events and consequently can address only a small segment of the health problems that affect the elderly population.

Passive environmental sensors, including motion sensors and sensors detecting the use or movement of common household articles, share the drawback that the data generated is often coarse. As a result, it is difficult, if not impossible, to draw conclusions with a high degree of confidence about changes in behavior that may indicate critical events without having to outfit the living environment with such a great number of sensors that real world installations outside of a laboratory environment often become impractical.

Other systems that study behavior patterns at an aggregate level, such as a daily activity sequence, suffer from issues where abnormal patterns of behavior are manifested in how an activity is performed, rather than when, or if, the activity is performed, as aggregate data about the behavior of the person, including, but not limited to, the time-window an activity is done, a sequence of activities etc., may not change, even though an individual may already be exhibiting abnormal behavior that can be detected in more subtle activity and body part movement patterns.

In the case of systems that perform body posture analysis, body posture analysis may detect some falls, but it does not address well situations where very different behaviors are performed with similar body posture. Body posture analysis is much too coarse to detect more subtle changes in behavior that may precede an adverse event. For example someone who feels unwell and lies down on a sofa could easily be confused for someone who is reading on a sofa. As a result, the alarm is not necessarily triggered until much later when an abnormally long time has passed. Moreover, obtaining sufficient data from practical sensor placements to continuously monitor body posture is difficult, resulting in locations and postures where no data is received and events cannot be detected.

There are many instances where information about body posture may not be available. For example, if a person is partly obscured, then a method that does not require information about the body posture is needed. Also, in some instances, it is undesirable that an image is studied. For example, if the object and situation studied is a person in a private setting, it is preferable to be able to extract behavioral information without the need to capture and then interpret an image.

Aspects of embodiments of the present technology can employ a method which is versatile enough that the method can detect adverse events in different circumstances where only partial information about the body is available. The partial information is for different parts of the body in different circumstances, and that said detection is done in a timely manner. Further, the present technology includes a method to predict possible future adverse events through the study of subtle changes in movements of body parts. Small changes in how activities are performed, that may not be readily apparent to the naked eye, may appear slowly over time and therefore may not manifest as large deviations from one day to the next. Such trending deviations can hold clues to the health of the user. Such small changes may precede the occurrence of larger adverse events, such as a stroke or a fall, and may warrant a health check-up by an appropriate caregiver or immediate assistance for the user.

A need therefore exists for a system that can give early warning about changes in health to avoid potential future events and can quickly detect the occurrence of an adverse event by detecting subtle changes in behavior. For example, the present technology may integrate plural sensing and/or analyzing elements into a single system capable of automatically creating a sufficient detailed behavior profile to give early warning about potentially adverse changes in health without specific a priori information regarding the person's daily habits or environment and without having to use personal identifying information.

The present technology can detect behaviors by monitoring individual limbs, other body parts, the whole body, or combinations not otherwise sufficient to determine posture, for activity patterns indicative of behavior patterns. While it may be possible in some instances to determine body posture from aggregated information, the present technology can employ aggregated information that is insufficient to identify posture to detect normal and abnormal behavior patterns.

In one embodiment, the subject technology is directed to a computer-implemented process for detecting and predicting events occurring to a person. The process includes the steps of: observing, using a sensor, a plurality of readings of a parameter of the person, wherein the parameter is one of: horizontal location, vertical height, and time of observation; storing the readings in a computer memory; determining, by a processor, a pattern of behavior based on the readings; storing a pattern of interest based on the readings; identifying from the readings the pattern of interest; distinguishing a person that exhibits the pattern of interest, from other people or animate objects; labeling the person with a unique identifying label; linking data captured about the person with the identifying label; determining conditions under which a subset of the readings correspond to an occurrence of an event; and detecting when the subset of readings corresponds to the occurrence of the event. The computer-implemented process may identify that a future abnormal event is likely to occur. Observing the reading of the parameter of the person may further comprise sensing the parameter for one body part from the group consisting of the person's head; the person's torso; the person's limbs; a combination of two or more of the person's head, the person's torso, and one of the person's limbs, wherein the combination is less than needed to define the person's posture; the person's whole body; and like combinations. In connection with any of the variations on observing, above, identifying may further comprise identifying the combination of one or more readings corresponding to the abnormal event when at least one other body part is obscured from the sensor. The computer-implemented process may further comprise computing velocity and/or orientation from a sequence of the readings.

The computer-implemented process including identifying a combination of readings corresponding to a normal event may further comprise learning to differentiate between the normal event and the abnormal event by applying a statistical test to the sequence of readings. The statistical test may be correlation. The computer-implemented process may further comprise identifying a combination of readings corresponding to a normal event. The computer-implemented process including identifying a combination of readings corresponding to a normal event may further comprise identifying a combination of readings representing an activity of daily living. Observation may further comprise: sensing an output of a wearable sensor; sensing an output of one of: a visual camera, infrared camera, and acoustical detector; sensing an output of a radio-wave measuring device; and sensing an output of a light-wave measuring device.

The process may be practiced using a computing machine including a computer memory; a sensor; and a computer processor. All of the foregoing variations may be practiced on such a computing machine. Moreover, the sensor may be any one or combination of a wearable sensor; a visual camera, infrared camera, and acoustical detector; a radio-wave measuring device; and a light-wave measuring device.

It should be appreciated that the subject technology can be implemented and utilized in numerous ways, including without limitation as a process, an apparatus, a system, a device, a method for applications now known and later developed or a computer readable medium. In the following description, reference is made to the accompanying drawings, which form a part hereof, and in which are shown example implementations. It should be understood that other implementations are possible, and that these example implementations are intended to be merely illustrative.

### DESCRIPTION OF THE DRAWING

So that those having ordinary skill in the art to which the disclosed system appertains will more readily understand how to make and use the same, reference may be had to the following drawings.

FIG. 1 illustrates a monitoring system according to an exemplary embodiment of the present technology.

FIG. 2 illustrates a flow chart for an exemplary implementation of the monitoring process of FIG. 1.

FIG. 3 illustrates a flow chart for an exemplary implementation of the data extraction process of FIG. 1.

FIG. 4 illustrates a flow chart for an exemplary implementation of the activity information extraction process of FIG. 1.

FIG. 5 illustrates a flow chart for an exemplary implementation of the behavior profile assessment process of FIG. 1.

FIG. 6A illustrates a flow chart for an exemplary implementation for associating extracted data with an appropriate user for the data extraction process of FIG. 1.

FIG. 6B illustrates a flow chart for an exemplary implementation for associating extracted data with an appropriate user for the data extraction process of FIG. 1.

FIG. 7A illustrates a flow chart for an exemplary implementation for associating extracted data with an appropriate user for the data extraction process of FIG. 1.

FIG. 7B illustrates a flow chart for an exemplary implementation for associating extracted data with an appropriate user for the data extraction process of FIG. 1.

FIG. 8 illustrates a flow chart for an exemplary implementation of a conditional rules process.

FIGS. 9A-H illustrates flow charts for exemplary implementations of the monitoring process of FIG. 1.

FIG. 10 illustrates an exemplary variation of the monitoring system according to an exemplary embodiment of the present technology.

FIGS. 11A-C illustrate flow charts for exemplary variations of the monitoring process of FIG. 10.

FIG. 12 illustrates a flow chart for an exemplary variation of the movement sequence assessment process of FIG. 10.

FIG. 13 illustrates a flow chart for an exemplary variation of the alert assessment process of FIG. 10.

FIGS. 14A-E illustrate flow charts for exemplary implementations of the monitoring process of FIG. 1.

FIGS. 16A-D illustrate exemplary implementations of an exemplary variation of the monitoring system of FIG. 1 using an optical and thermal imager.

FIGS. 17A and 17B illustrate flow charts for exemplary implementations of the monitoring process of FIG. 1.

### DETAILED DESCRIPTION

Exemplary embodiments of the present technology will now be described in detail with reference to the accompanying figures. The advantages, and other features of the system disclosed herein, will become more readily apparent to those having ordinary skill in the art from the following detailed description of certain preferred embodiments taken in conjunction with the drawings which set forth representative embodiments of the present invention and wherein like reference numerals identify similar structural elements.

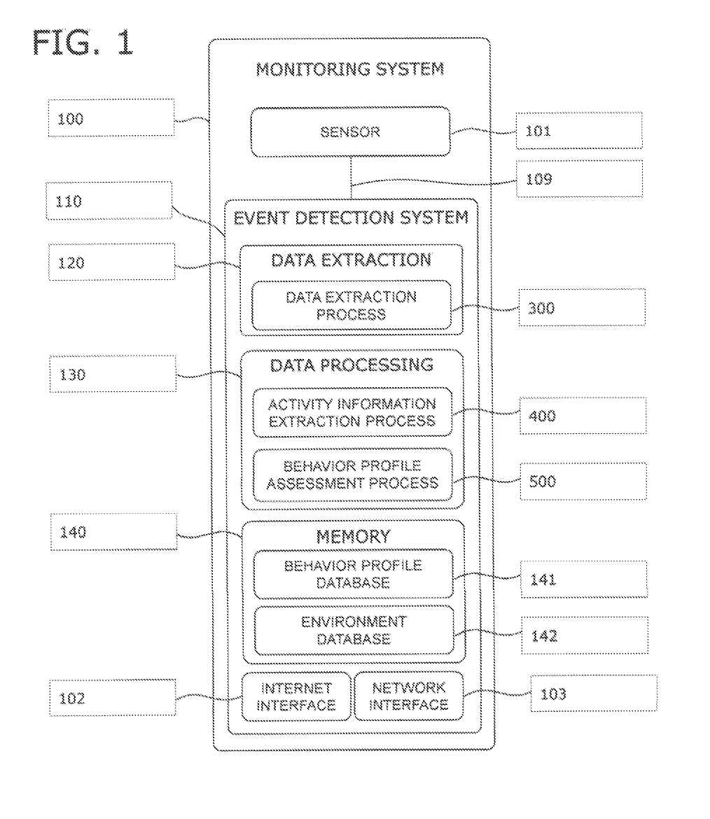

FIG. 1 illustrates a monitoring system according to an exemplary embodiment of the present technology. For sake of brevity, the person studied, will henceforth be referred to as “user”. The behavior of the user is captured through sequential observation of a, body part, or parts, of the user based on some combination of horizontal location, vertical height, orientation, velocity (velocity being the vector whose values represent speed and direction), and the time of observation of said body part, or parts.

The observed data is used to continuously create and update a behavior profile against which future observations are compared. Correlation is used to determine a pattern of behavior for said body part, or parts.

Adverse events are detected, or possible future adverse events predicted, by detecting changes in pattern in the above-observed dimensions for a body part, or parts, that through correlation are determined to indicate significant changes in behavior. At any time, a minimum set of data is determined to deviate when an observed pattern is inconsistent with past observed data, or in a way that cannot reasonably be inferred from past data to correspond to normal behavior.

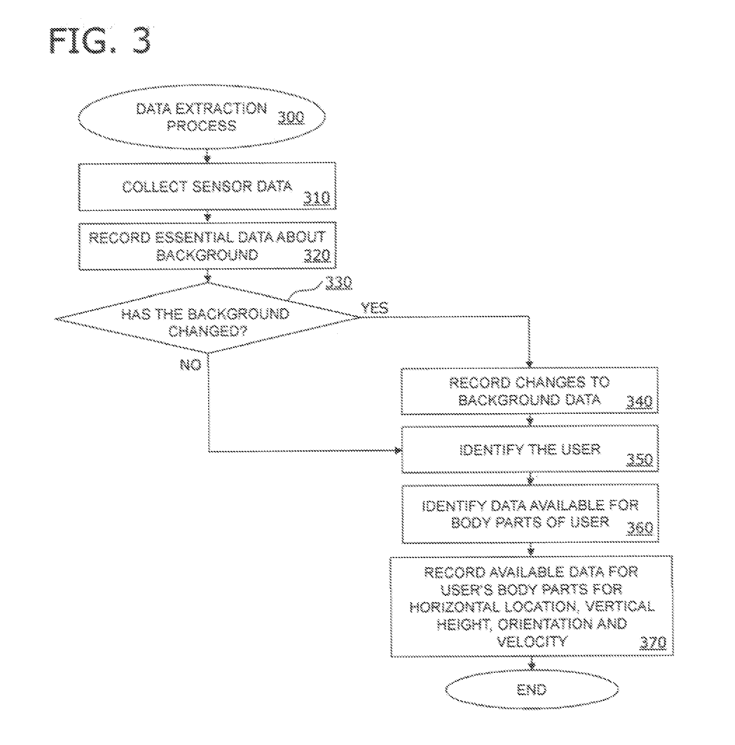

In FIG. 1, the blocks may be one or more of, or a combination of, software modules; hardware modules; software executing on a general purpose computer including sensors, memory, a processor, and other input and output devices; and, special purpose hardware including sensors, memory, a processor, and other input and output devices. Sensors used can include cameras, and other sensors described in detail in conjunction with FIG. 3, from the outputs of which the measurements of body part parameters can be extracted, as described below.

Still referring to FIG. 1, an exemplary monitoring system 100 is shown that includes an event detection system 110, connected to one or more sensors 101, the Internet, and/or a phone network and the like through interfaces 102, 103 such as a local network. Sensors 101 capture and/or record multi-dimensional data of horizontal location, vertical height, orientation, velocity, and time of observation, or a combination thereof. The data captured is relayed as a continuous data feed 109 to the event detection system 110. At any given time, from the data feed 109, said multi-dimensional data is extracted by the data extraction module 120 running a data extraction process, where possible, for the body parts of the observed user. The data extracted by the data extraction module 120 is subsequently processed by the data processing module 130 for evaluation and to build a behavior profile. A log of events and other data, about the user and the environment the user that is determined relevant for event detection and the behavior profile, are stored in memory 140 and the behavior profile database 141 and environment database 142.

The flow charts herein illustrate the structure or the logic of the present technology, possibly as embodied in computer program software for execution on a computer, digital processor or microprocessor. Those skilled in the art will appreciate that the flow charts illustrate the structures of the computer program code elements, including logic circuits on an integrated circuit, that function according to the present technology. As such, the present technology may be practiced by a machine component that renders the program code elements in a form that instructs a digital processing apparatus (e.g., computer) to perform a sequence of function step(s) corresponding to those shown in the flow charts.

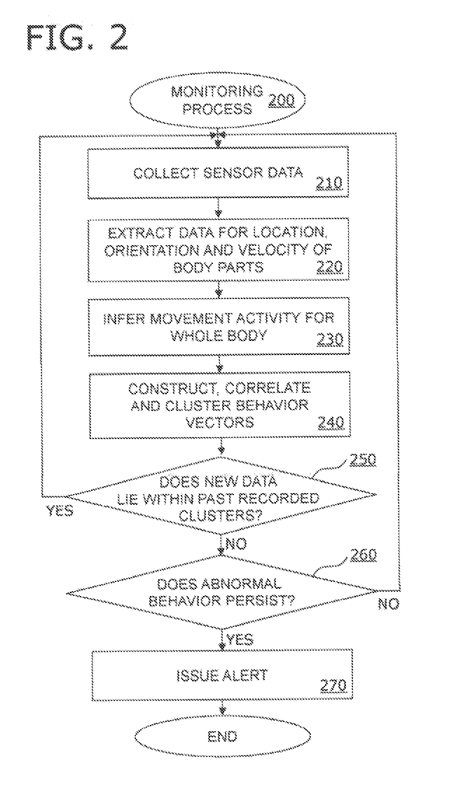

FIG. 2 illustrates a flowchart for an exemplary implementation of a monitoring process 200 that can be practiced using the system of FIG. 1. In step 210, data is collected, at any given time, about the user's body parts by one or more sensors 101 for horizontal location, vertical height, orientation, velocity, and time of observation. In step 220, available data for different body parts is extracted. The data is associated with different body parts through data collection and, or, historical information on movements. This process is further discussed in conjunction with FIG. 3.

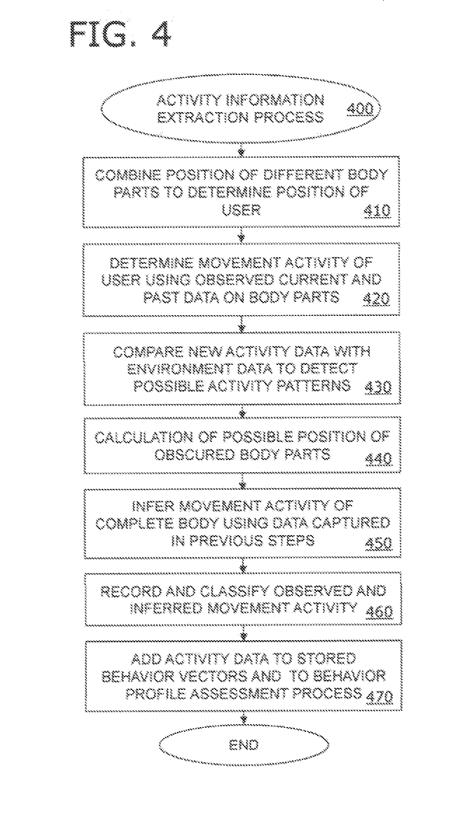

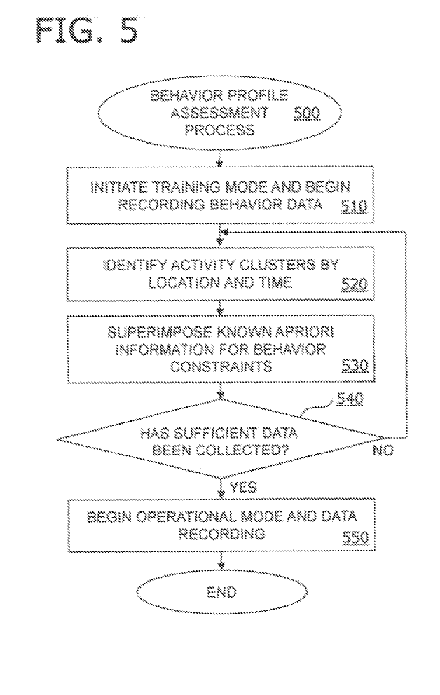

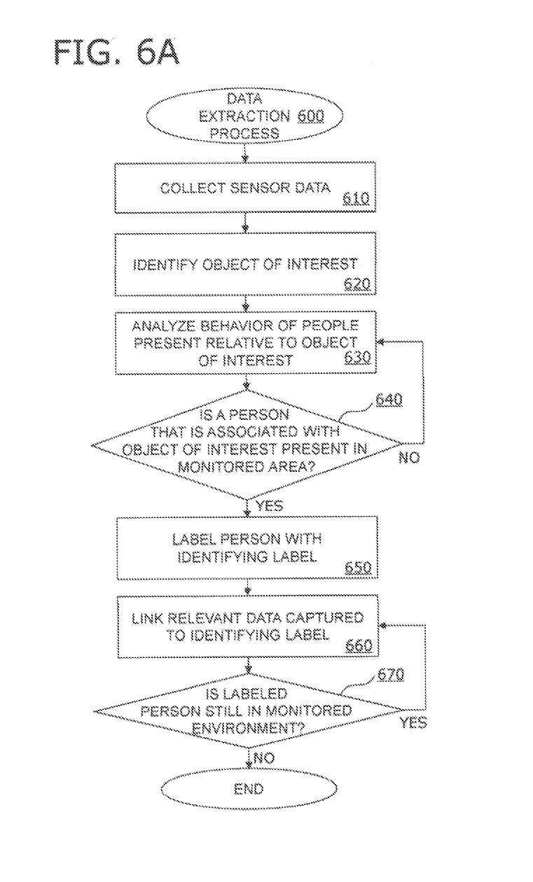

In step 230 of FIG. 2, the activity of the whole body is inferred from observed, and inferred, body part movements. This process is further discussed in conjunction with FIG. 4. In step 240 of FIG. 2, the activity information data from step 230 is used to construct n-dimensional behavior vectors that are stored in a behavior profile database 141 (see FIG. 1). These n-dimensional behavior vectors are evaluated for correlations and clusters that may indicate behavior patterns. This process is further discussed in conjunction with FIG. 5.

In step 250 of FIG. 2, the new n-dimensional behavior vectors from step 240 are compared with a behavior profile constructed with past recorded data, stored in behavior profile database 141, and determining whether or not this new measurement lies within any of the clusters described above. If the new data does lie within any of the clusters described above, then this represents normal behavior and the process 200 starts again at step 210. Further, the above recorded new data is added to the moving averages using an appropriate moving average technique e.g. simple, weighted, or exponential moving average etc., to further refine the normal behavior profile stored in the behavior profile database 141.

Still referring to step 250 of FIG. 2, if the data does not lie within any of the clusters described above, the process 200 proceed to step 260. At step 260, the new measurement is flagged as abnormal and additional data is accumulated. If the additional data collected lies within previously recorded clusters, described above, the process starts again at step 210. In step 270, if the abnormal behavior persists, a warning message is sent to appropriate responders.

FIG. 3 illustrates an exemplary data extraction process 300. In step 310 the sensor data feed 109 is collected from one or more sensors 101. In step 320, a learning process is initialized by recording essential data by the sensor, or sensors, about the environment the user is in. For purposes of illustration, all objects that are not directly associated with the movement activity of the user are considered background and the terminology background and environment are used interchangeably. This essential data is recorded and stored in the environment database 142 in memory 140 (see FIG. 1). Essential data includes, but is not limited to, spatial data, and non-spatial data, e.g., colors, texture, etc., about floors, ceilings, walls, large and small stationary, and non-stationary, objects, as well as sensory data, e.g., light, temperature, barometric pressure, etc.

In step 330, new background data is compared to previous background data to determine significant changes to the environment. Examples include, but are not limited to, movement of stationary and non-stationary objects, changes in light conditions, and changes in temperature. If the background has changed, the process 300 proceeds to step 340. In step 340, when the background has changed, the type of change is recorded, time stamped and stored in the background environment database 142.

If the background has not changed, the process 300 proceeds to step 350. In step 350, the sensor data is further processed and data describing the user is identified through a process of a combination of one, or more, of identification of moving objects, suppression of background recorded in step 320, utilization of information about changes recorded to the background in step 340, or by using known methods for feature extraction and identification of the user including, but not limited to, those described in the book Feature Extraction & Image Processing for Computer Vision, 3^{rd} edition, Nixon, M., and Aguado, A., Academic Press, 2012, incorporated herein by reference.

In step 360, observable body parts of the user are identified using data extracted about the user from step 350 and a combination of one or more methods for feature extraction, exemplary methods include, but are not limited to, principal component analysis, threshholding, template matching, etc. In step 370, available data for each body part for horizontal location, vertical height, orientation and velocity, is recorded.

Variations of exemplary embodiments utilize different types of sensors 101 for data extraction about user and background. Depending on the types of sensors utilized, the exact data captured about a user's body parts may be more or less accurate for observing information on horizontal location, vertical height, orientation, velocity, and time of observation for the respective body parts. The data that can be recorded about the environment, i.e., background, will also differ in terms of spatial, and non-spatial, data and sensory data that can be recorded and what environmental information and constraints can be extracted. Notwithstanding these differences in the data extracted, processes for activity information extraction and behavior profile assessment are agnostic as to how the data on body parts and environment have been extracted.

The following are exemplary embodiment variations for the data extraction process when using the following different types of sensor categories: wearable sensors, cameras e.g., visual, infrared etc., acoustical detectors, radio-wave measuring devices, or light-wave measuring devices.

In an exemplary implementation variation of sensors 101, using wearable sensors, sensors could be affixed to multiple tracked body parts, each sensor observing data on, one or more of, multi-dimensional data on horizontal location, vertical height, orientation, velocity, and time of observation for the body part the sensor is affixed to. The information may be captured by the sensor through multiple sensor subunits. Sensor subunits may include, but are not limited to, movement, position, vital sign, and environment measurement subunits. Sensors and environment measurement subunits and other subunits may further include, but are not limited to, accelerometers, gyroscopes, barometers, magnetometer, GPS, indoor GPS, vital sign measurement sensors, etc.

Alternatively the sensors may capture a subset of said multi-dimensional data about a body part, such as vertical height, orientation, velocity and time of observation, and the remaining multi-dimensional data, an example being the horizontal location, where horizontal location is calculated based on the absolute, or relative, horizontal location of the wearable sensor vis-à-vis the global coordinate system, monitoring system 100, or other relative point of measurement, using a positioning method, e.g. dead-reckoning, received signal strength identification methods, triangulation, directional Bluetooth, Wi-Fi, etc. Although the wearable sensors may not capture all the multi-dimensional data they may be effectively complemented by a non-wearable sensor, as illustrated by the above exemplary implementation that captures additional complementary multi-dimensional data.

Similarly, as described by the above illustrative example, other data that may be captured by a non-wearable sensor could include the vertical height, orientation, or velocity of the wearable sensor may be determined using absolute, or relative, vertical height, orientation, or velocity of the wearable sensor vis-à-vis the global coordinate system, monitoring system 100, or other relative point of measurement.

The wearable sensors may in addition capture information about the environment, e.g. temperature, light conditions, etc. and generate data that can be of assistance in inferring information about the environment e.g. spatial constraints etc. The sensor data feed, 109, may be transmitted to the monitoring device 110 through methods such as radio waves, e.g. CDMA, GSM, Wi-Fi, Near Field Communication, ZigBee, BTLE etc., or light waves, e.g. lasers etc.

In an exemplary implementation variation of sensors 101, using camera sensors, sensors could be capturing images of the user's body parts and surrounding environment. Exemplary camera sensors may capture different types of images, including, but not limited to visual-, depth-, infrared-, acoustic-images, etc., that enable observation of, one or more of, said multi-dimensional data on horizontal location, vertical height, orientation, velocity, and time of observation for a body part.

In an exemplary implementation variation of sensors 101, using acoustical detectors, sensors could capture and/or generate sounds, audible or ultrasonic, that help in the determination of, one or more of, the multi-dimensional data on, horizontal location, vertical height, orientation, velocity, and time of observation for the body part. Such sounds may include, but are not limited to, body part observation, e.g., locating a voice, identifying walking sounds, detecting an impact noise, or observing the environment, e.g., through detection of environmental changes, presence of other people, breaking sounds, etc.

In an exemplary implementation variation of sensors, 101, using radio-wave measuring sensors, sensors could be capture and/or generate radio-waves to identify the user's body parts and surrounding environment. Exemplary radio-wave sensors may generate and/or capture different types of radio-waves using methods, including, but not limited to, radar etc., that enable observation of, one or more of, said multi-dimensional data on horizontal location, vertical height, orientation, velocity, and time of observation for a body part.

In an exemplary implementation variation of sensors 101, using light-wave measuring sensors, sensors could capture and/or generate light-waves to identify the user's body parts and surrounding environment. Exemplary light-wave sensors may generate and/or capture different types of light using methods, including, but not limited to, laser imaging detection and ranging, photo sensors, structured light, etc., that enable observation of, one or more of, said multi-dimensional data on horizontal location, vertical height, orientation, velocity, and time of observation for a body part.

FIG. 4 illustrates an exemplary activity information extraction process 400. In step 410, data is captured in an n-dimensional vector for the user at a corresponding time period. For illustration purposes, the time period is denoted to, for different body parts are combined to determine the position of the user at to. The process 400 has been completed for the preceding time periods t₋₁, t₋₂ . . . , etc., and is repeated for the following time periods t₁, t₂ . . . , etc.

In step 420, the sequence of n-dimensional vectors are studied to determine the likely movement activity of the user using observed information on, horizontal location, vertical height, orientation, velocity, and time of observation for the respective body parts. In step 430, observed movement activity is further compared with recent changes in data in the environment database 142 to detect possible activity patterns. In step 440, body parts that are fully, or partly, obscured are identified and their possible current positions are calculated using, past recorded positions of body parts and current positions of other identifiable body parts. If applicable, any section of the body part that can be observed, as well as, available data on recent changes in background environment, past observed relative body part positions and movement patterns in relation to other body parts, and environmental constraints are stored in environment database 142. A likelihood function, with environmental constraints, is used to determine the most probable position of obscured parts.

In step 450, the movement activity of the complete body is inferred from the data captured in steps 410, 420, 430 and 440. In step 460, the observed, and for unobserved body parts, inferred, movement activity of different body parts, are recorded and, if relevant, classified and labeled. In step 470, all the activity data recorded in step 460 is added to the n-dimensional behavior vectors and stored in memory 140 and used in behavior profile assessment process 500.

FIG. 5 illustrates an exemplary behavior profile assessment process 500. In step 510, the system 100 is in a training mode and begins to construct a behavior profile. The construction is begun by recording the movement activity recorded by activity information extraction process 400 and generated in step 470 (e.g., observed and inferred data for all body parts for horizontal location, vertical height, orientation, velocity, and time of observation, or any combination thereof). This data is used to form an n-dimensional behavior vector for each time period. Each independent measurement is used to construct one dimension of an n-dimensional vector.

In step 520, the system 100, still in training mode, identifies clusters of the n-dimensional behavior vectors; these clusters are then used to define normal behavior. In step 530, if any a priori knowledge of the subject's behavioral habits is known, such knowledge can be superimposed upon the sample vectors to produce a highly constrained dimension in the n-dimensional behavior vector space. The resulting n-dimensional vectors are stored in the behavior profile database 141.

In step 540, the training mode is terminated, in an exemplary implementation, this may be done automatically, by employing a standard internal evaluation techniques such as the Davies-Bouldin index, etc., or, alternatively, the training mode may be terminated by imposing some external criteria, e.g. a statistical parameter, arbitrarily imposed period of time, etc. In step 550, the operational mode is begun where new data is recorded periodically during the day, constructing new n-dimensional behavior vectors as described in conjunction with FIG. 2 where the details of the operational mode of the monitoring process are described.

Exemplary statistical techniques that may be employed to correlate body part movements and to construct behavior profiles by means of constructing n-dimensional behavior vectors include, but are not limited to, standard multivariate analysis (see, Applied Multivariate Statistical Analysis, 6th edition, Johnson, R. A., and Wichern, D. W., Prentice Hall, 2007, incorporated herein by reference). The cluster analysis for this initial data can be in the form of centroid based clustering (i.e. k-means clustering) or even density-based clustering. An exemplary refinement is to analyze the data for long-scale periodic structure (such as weekly or monthly anomalies) including, but not limited to, techniques such as those described in the article Detection and Characterization of Anomalies in Multivariate Time Series, Cheng H., Tan, P.-N., Potter, C., and Klooster, S. A., Proceedings of the 2009 SIAM International Conference on Data Mining, 2009, incorporated herein by reference.

Exemplary systems incorporating aspects of embodiments of the present technology can also contain an evaluation mode for quality control where the statistical data is compared to known a priori information. This is an external evaluation process that checks the results produced by such systems, enabling them to refine the event detection process and accuracy. The external evaluation need not, however, be performed continuously during ordinary operation of such systems.

An exemplary evaluation process may compare the clusters produced by the statistical algorithms of the ordinary operation of a system to a benchmark metric using one, or more, statistical methods e.g. computing the Fowlkes-Mallows index, Rand measure etc. The a priori information used in these evaluations may be included in the calculation of the cluster centroids to produce a more precise personal behavior profile, but the a priori information is not required for proper operation during the ordinary operation of the system. In an exemplary implementation this evaluation is part of a quality control and software development process to assure that the algorithms are sufficiently robust and that no errors, either intentional or unintentional, have migrated into the software. Unlike conventional systems, the a priori knowledge required to conduct this evaluation is not a requirement for implementation.

An exemplary embodiment of the present technology includes aspects to associate, or identify, users that spend time in an environment with objects, or locations, in the environment based on how the users relate to those objects, or locations i.e., a “pattern of interest”. Data captured about the users are labeled with unique identifiers to help further study.

Embodiments of the present technology can be applied to data capture methods so as to enable the correlation of data captured with the appropriate user. Preferably, the method is 1) automatic (does not require manual labor), 2) can deal with environments where multiple users are present, and 3) does not require that data is associated with a person name or other personal ID (in order to increase privacy and eliminate ID errors).

The following is an exemplary method: 1. In the first step, a user is associated with an object or place based on patterns of movement in and around, or usage of, objects and/or environment (“the pattern of interest”), a user are given one or more label that function as an identifier for each user. In an exemplary implementation, a bed, chair, bathroom, or bedroom etc. is associated with a user that uses that bed, chair, bathroom, or bedroom etc.; 2. In the second step, the user that has been associated with the object is given a unique identifying label (“unique label”); 3. In the third step, data captured about the user is linked to the identifying label; 4. In the fourth step, if the user exits the observed environment the process of associating data is interrupted and restarted from the first step when a user again is observed as exhibiting “the pattern of interest”.

In one exemplary variation, a user is associated with a particular object of interest (e.g., bed, chair etc.) or place (e.g., bedroom, bathroom). The system 100 may track a user based on who is sleeping in the bed and keep tracking the users as the users move around.

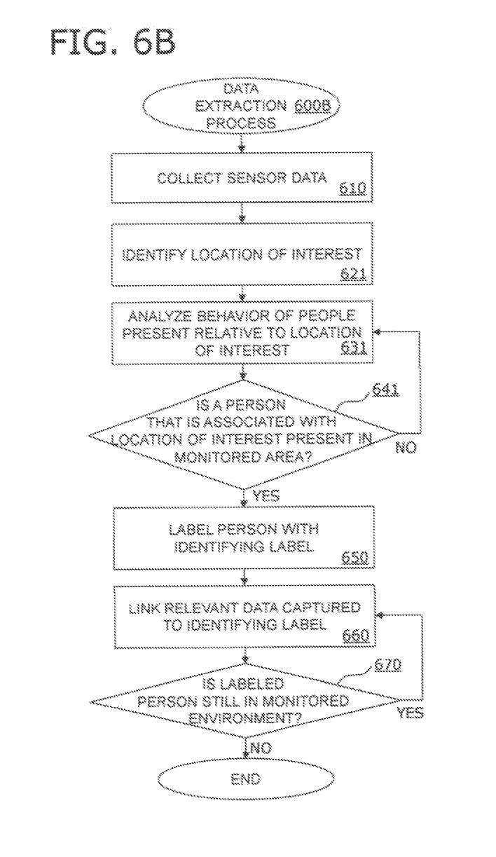

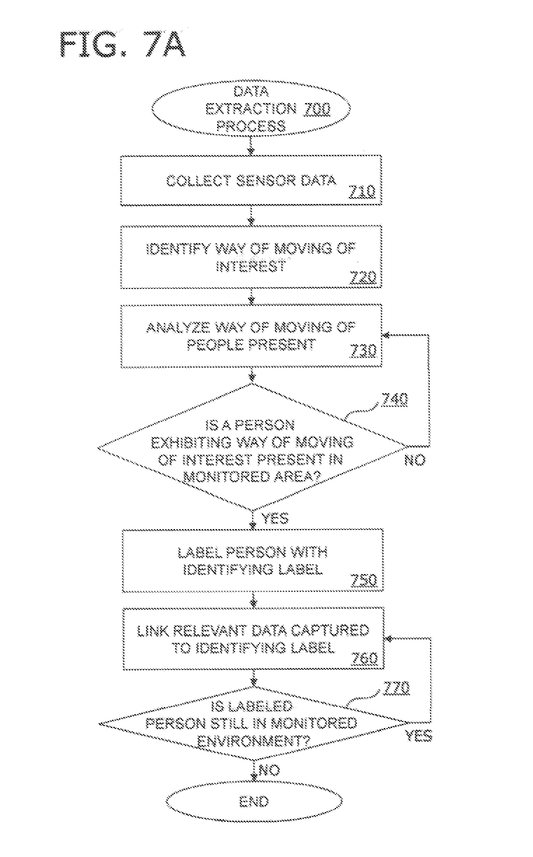

Exemplary variations of embodiments of the present technology are shown in FIGS. 6A and 6B. FIG. 6A shows an exemplary implementation variation of the data extraction process 600 and of the process for identifying the user in step 350. In step 610 sensor data is collected. From the sensor data, the object of interest is identified in step 620 using standard foreground and background extraction techniques and other methods listed in U.S. patent application Ser. No. 13/840,155, as well as other statistical techniques, or the object may be selected or specified by an external actor or using data internal, or external, to the environment.

In step 630, the system 100 analyzes the behavior of people that are present in the monitored environment with respect to the identified object. The analysis may include using statistical techniques and other methods listed in U.S. patent application Ser. No. 13/840,155. Next, in step 640, the data extraction process determines, using one or more of the exemplary methods described in step 630, if a user that is associated with the object is present in the monitoring area. That a user is associated with an object is determined by using exemplary methods such as statistical techniques, e.g., where movement vectors of the user are constructed, correlated, and clustered.

The movement vectors are also analyzed in relation to object location, or other techniques, e.g., comparing movement patterns to constraints or rules that have been generated based on past historical movement patterns or that are set by an external source or actor. If, in step 630, the answer is no, i.e. no user that is associated with the object is present in the monitoring area, the process 600 returns to step 630, whereas if the answer is yes, then the process 600 continues to step 650 where the user identified as being associated with the object of interest is labeled with an identifying label.

In step 660 relevant data, i.e. data that is generated from or by the user who has been associated with the object of interest, is linked with the identifying label. The data that has been linked with the identifying label, and the identifying label itself, may at this point, or at a future time period, be used for further data processing, analysis, or stored in memory for retrieval as necessary. In step 670, the data extraction process checks if the user that is to be monitored is still in the monitored environment, if yes, then the monitoring continues to step 660, if not, then the data extraction process is interrupted or restarted from step 610.

FIG. 6B shows another exemplary variation of the present technology in which the data extraction process 600B is modified so that the user to be tracked is identified based on movement patterns in relation to a location in the monitored environment, rather than an object in the monitored environment as exemplified in FIG. 6A.

An exemplary embodiment of the present technology includes aspects to identify users that spend time in an environment based on their relative body characteristics (e.g., height, shape, etc.) or general way of moving (e.g., gait, posture, etc.). Data captured about the users are labeled with unique identifiers to help further study.

Embodiments of the present technology can be applied to data capture methods so as to enable the correlation of data captured with the appropriate user. The method is 1) automatic (does not require manual labor), 2) can deal with environments where multiple users are present, and 3) does not require that data is associated with a person name or other personal ID (in order to increase privacy and eliminate ID errors).

A sensor, or sensors, is used to observe an environment. The following method is applied. 1. In the first step, a user is associated with body characteristics (e.g., height, shape, etc.) or way of moving (e.g., gait, posture, etc.) (“the pattern of interest”), users are given one or more labels that function as an identifier for each user. In an exemplary implementation a user that walks with a particular gait, e.g., a particular limp, gait speed etc., is given a unique identifying label (“unique label”). 2. In the second step, data captured about the user is linked to the identifying label. 3. In the third step, if the user exits the observed environment the process of associating data is interrupted and restarted from the first step only after a user again is observed as exhibiting “the pattern of interest”.

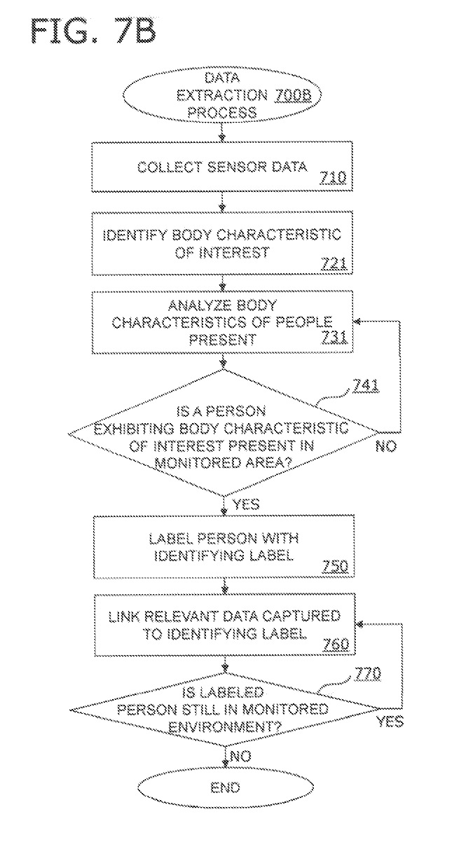

Exemplary variations of embodiments of the present technology are shown in FIGS. 7A and 7B. FIG. 7A shows an exemplary implementation variation of the data extraction process 300 and of the process 700 for identifying the user in step 350. In step 710, sensor data is collected. From the sensor data, the “identifying way of moving” of interest is identified in step 720 using standard foreground and background extraction techniques and other methods listed in U.S. patent application Ser. No. 13/840,155, as well as other statistical techniques, or the way of moving may be selected or specified by an external actor or using data internal, or external, to the environment.

In step 730, the way of moving of people that are present in the monitored environment, is analyzed using statistical techniques and other methods listed in U.S. patent application Ser. No. 13/840,155. Next, in step 740, the monitoring process 700 determines, using one or more of the exemplary methods described in step 730, if a user is present in the monitoring area that exhibits the identifying way of moving. That a user exhibits the identifying way of moving is determined by using exemplary methods such as statistical techniques, e.g. where movement vectors of the user are constructed, correlated, and clustered and analyzed, or other techniques, e.g. comparing movement patterns to constraints or rules that have been generated based on past historical movement patterns or that are set by an external source or actor.

If, in step 740, the answer is no, i.e. no user exhibits the identifying way of moving is present in the monitoring area, the process 700 returns to step 730. If the answer is yes at step 740, then the process 700 continues to step 750 where the user identified as exhibiting the identifying way of moving is labeled with an identifying label. In step 760, relevant data, i.e. data that is generated from or by the user that exhibits the identifying way of moving, is linked with the identifying label. The data that has been linked with the identifying label, and the identifying label itself, may at this point, or at a future time period, be used for further data processing, analysis, or stored in memory for retrieval as necessary. In step 770, the monitoring process 200 checks if the user that is to be monitored is still in the monitored environment, if yes, then the process 700 continues to step 760. If not, then the monitoring process 200 is interrupted or restarted from step 710.

FIG. 7B shows another exemplary variation of the present technology in which the data extraction process is modified so that the user to be tracked is identified from body characteristics of people present in the monitored environment, rather than from a way of moving in the monitored environment as exemplified in FIG. 7A.

In an exemplary variation of the data extraction process a conditional rules process can be added to the variations described in FIGS. 6A and 6B, as well as FIGS. 7A and 7B. Rules with conditions (“condition”) that trigger an action (“action”) if met, or not met, can be associated with said “unique label”. Exemplary “conditions” could be “the user should not be on the floor”, “the user exits the bed”, “the user should not exit a bed without assistance”, etc. Exemplary “actions” could be “send an alert to xx person”, “turn on the lights”, etc.

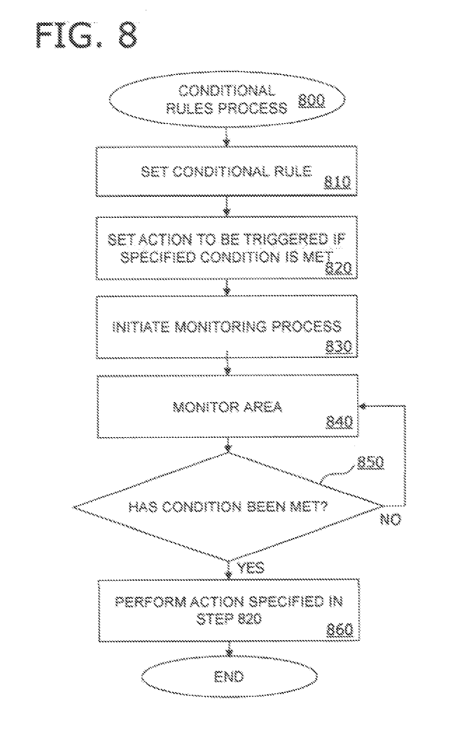

FIG. 8 illustrates an exemplary conditional rules process 800 that may, or may not, be used in combination with the monitoring process illustrated in FIG. 2. In an exemplary variation, the conditional rules process 800 is initiated by a conditional rule being set in step 810 by an external actor. In step 820, an action is specified that will be taken should the condition specified in step 810 be met. In step 830, the monitoring is initiated and the monitoring continued in step 840. In an exemplary variation, the monitoring process 200 illustrated in FIG. 2 is contained within step 840. In step 850, the data extracted and analyzed is continuously compared with the conditional rule specified. As long as the condition specified has not been met, the conditional rules process repeats the monitoring step 840. If, on the other hand, the conditional rule is met, then the conditional rules process continues to step 860. In step 860 the action that has been specified in step 820 is performed.

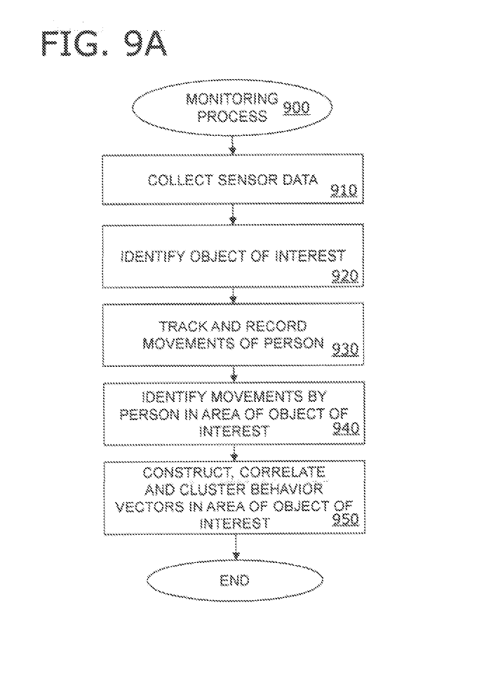

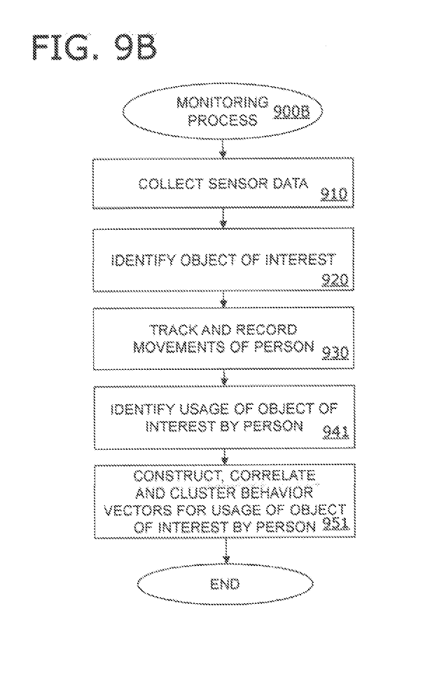

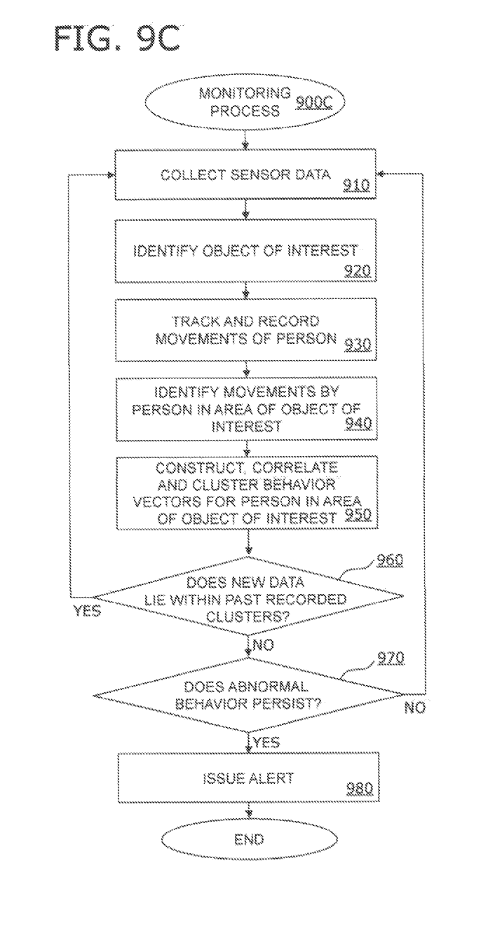

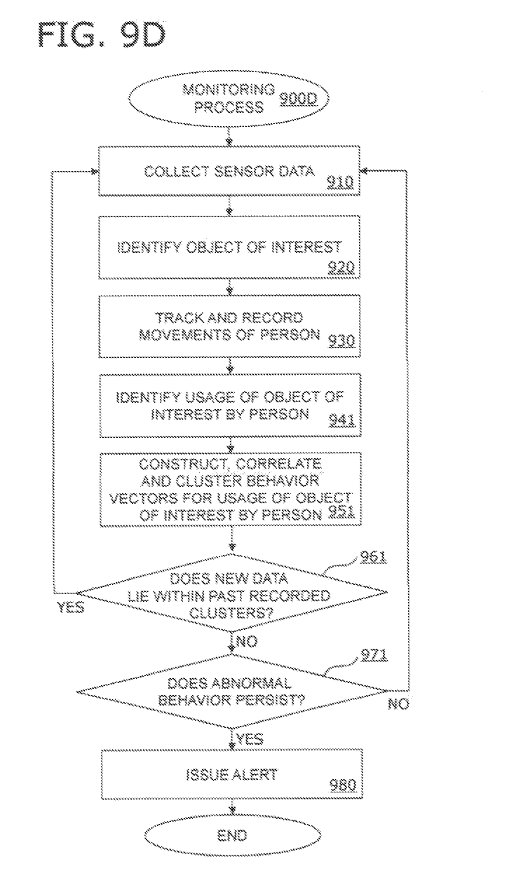

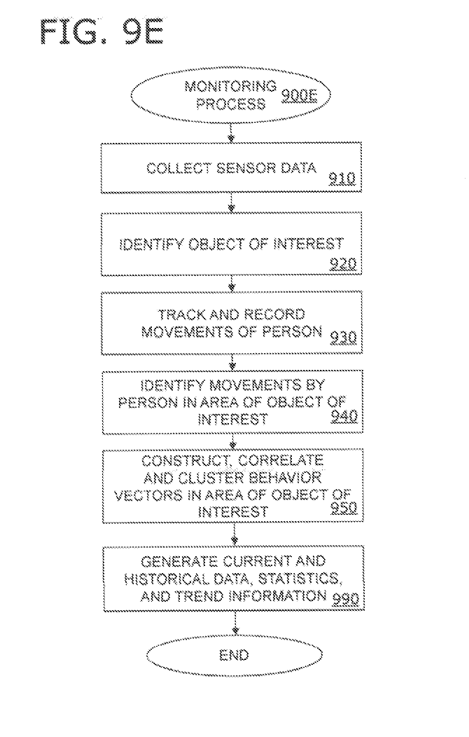

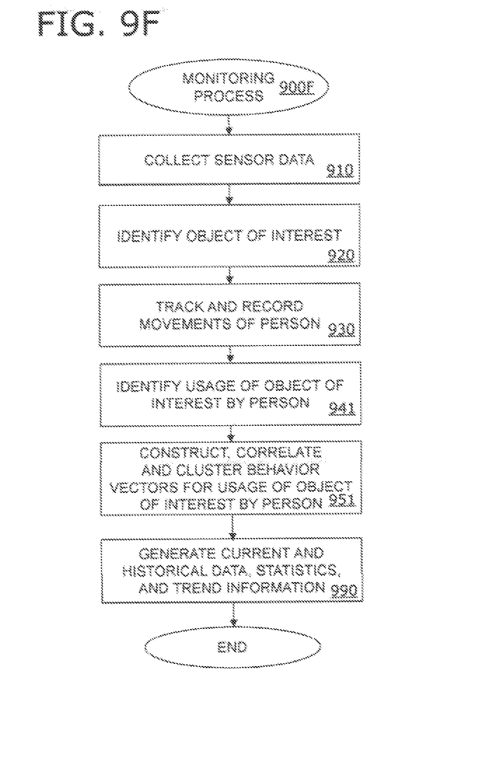

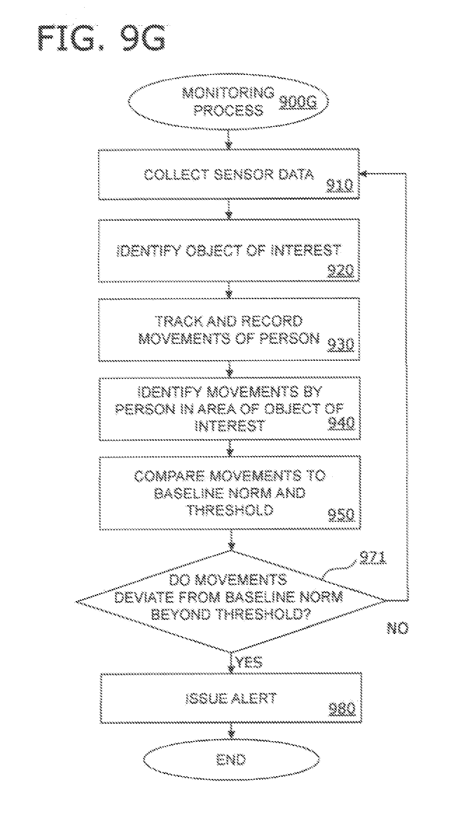

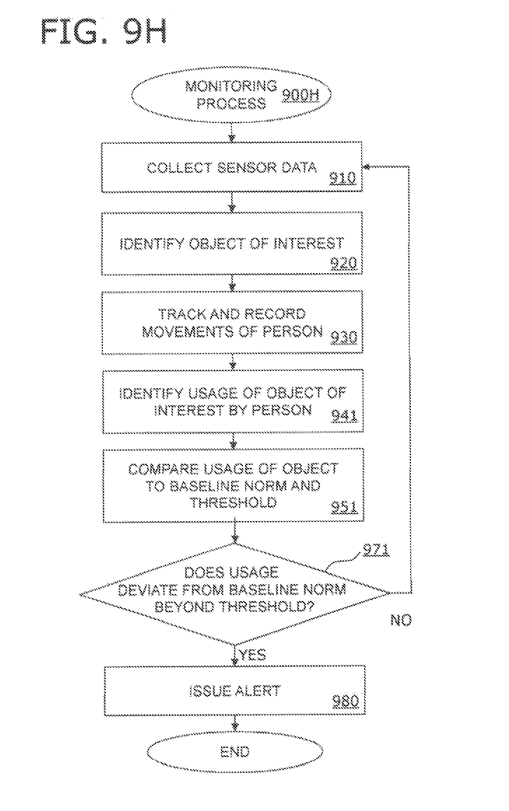

FIGS. 9A-H illustrate flowcharts for an exemplary implementation of a method that can be practiced using the system of FIG. 1. Aspects of embodiments of the present technology correlate the location of certain objects or locations with the behavior profile to capture and analyze “nested behaviors” e.g., a behavior pattern within a larger behavior pattern i.e. a sub-cluster of n-dimensional behavior vectors within a cluster of n-dimensional behavior vectors.

Next to certain objects, certain types of behaviors/movements are expected, independent of time period of day. Such typical objects are the bed, water faucet, dining room table, toilet, fridge, kettle, toilet, medicine bottle etc. If the movement at a determined point in time deviates significantly from previously recorded behavior patterns, it may be an indication that something is wrong and should be checked. The objects don't necessarily need to be known in advance. The objects can be determined based on these “nested behaviors”.

The present technology helps constrain what is to be monitored and aids studies of how something is being done, not just if it is done, or not done. Numerous variations, that can be applied to embodiments of the present technology individually or in any combination where they may logically be combined, are now described.

Movements may be captured using the methods and apparatus disclosed in U.S. patent application Ser. No. 13/840,155. Emphasis may be placed on using the location element (e.g., in bed, next to the bed, in a specific chair, bathroom etc.).

The system 100 uses sensors and statistical tests to detect, classify, monitor, and record “nested behaviors”, i.e. use of certain objects or locations, such as the medical cabinet, medicine bottles, kettle, toilet, refrigerator etc.

The system 100 uses information on “nested behaviors” to enhance a person's behavior profile. When these objects or locations are used, it may trigger an assessment of behavior vs. expected movement and usage patterns in time sequence for that object or location.

A “nested behavior” may be identified using “behavior templates” i.e. a model for what such a behavior typically looks like. The “behavior templates” could be created using exemplary methods such as: 1) having one, or more, actor(s) perform the behavior to be identified; 2) identifying and recording the behavior from a different set of users (preferable a large population); 3) asking the person that is to be studied to perform the behavior; or 4) using a historic movement profile for the person that is being studied and the like.

The system 100 compares and analyzes the “nested behavior” to a baseline or norm. Exemplary methods for creating the baseline or norm could consist of any of the methods described above or any other suitable method. An alert may be sent if a “nested behavior” deviates from the baseline or norm beyond a “threshold” that is created using one of the following exemplary methods: 1) set by an agent external to the system (e.g., a caregiver, administrator etc.); 2) calculated using historic movement profile, etc.

Exemplary variations of embodiments of the present technology are shown in FIGS. 9A-H. FIG. 9A shows an exemplary implementation of the monitoring process 900. In step 910, sensor data is collected. From the sensor data, the object of interest is identified in step 920 using standard foreground and background extraction techniques and other methods listed in U.S. patent application Ser. No. 13/840,155 or the object may be selected or specified by an external actor or using data internal, or external, to the environment. In step 930, the movements of the person are tracked and recorded in memory. In step 940, the movements by the person in the area of the object of interest are identified using one or more of the exemplary methods described in step 920. In step 950, in the area of the object of interest, behavior vectors of the person are constructed, correlated, and clustered.

FIG. 9B exemplifies another variation of the monitoring process 900B where the emphasis is on the usage of the object by the person, rather than the movement patterns of the person in the area of the object as in FIG. 9A.

In the exemplary variations of FIGS. 9C-D, steps are added to FIGS. 9A and 9B, respectively, in which in the step 960/961, the monitoring process 900C checks if the new data is within past-recorded clusters. If it is, then the data collection continues to step 910. If it is not, then the process 900C or 900D continues to step 970/971, respectively, where the monitoring process 900C or 900D checks if the abnormal behavior continues. If the abnormal behavior does not continue, then the data collection continues again to step 910, if, on the other hand, it does continue, then an alert is issued.

FIGS. 9E and 9F depict exemplary variations in which another step is added to FIGS. 9A and 9B where the data monitoring process 900E/900F, respectively, generates current and historical data, statistics and trend information for further analysis by an external agent or system.

FIGS. 9G and 9H show other exemplary variations of FIGS. 9A and 9B where movements are compared to a baseline norm in step 970/971 and if the movements deviate beyond a threshold norm, then an alert is issued.

According to embodiments of the present technology, a method and system monitors activity of a person to obtain measurements of temporal and spatial movement parameters of the person relative to an object for use for health risk assessment and health alerts. Current bed-exit and chair-exit alarms are unreliable, require considerable manual maintenance, and are very restricted in how they can be tailored for individual person needs.

According to some embodiments of the present technology, the method or system may include receiving at a processor, 3D data from at least one 3D sensor associated with a particular person and a particular object; identifying at the processor, a sequence of movements corresponding to movements by the person relative to the particular object; analyzing at the processor, the sequence of movements corresponding to movements by the person relative to the particular object, to generate one or more parameters; and, performing, at the processor, at least one assessment based on the one or more parameters to determine a probability score.

The method and system described above may be varied by the addition one or more of the following variations. The following variations may be applied to embodiments of the present technology individually or in any combination where they may logically be combined.

The 3D sensor may be one or more of a: 1) depth camera; 2) time of flight sensor; 3) Microsoft Kinect sensor; and 4) any other suitable sensor that can be used to determine a person's position in a 3D space, such as any of the types of sensors listed in U.S. patent application Ser. No. 13/840,155.

Some embodiments may include more than one processor. The particular object from which the person's exit is monitored may be one of a: 1) bed; 2) chair; 3) sofa; or 4) other piece of furniture.

The sequence of movements identified by the method or apparatus, that may be performed by the person relative to the particular object is to: 1) leave/exit; 2) enter; 3) stand up; 4) sit up; 5) sit or lie down; 6) sit back, or 7) other movement relative to object and the like.

The probability score may be the probability that a person has taken one of the movement sequences that the method or apparatus can identify. The probability score may be compared with a predefined value that defines a significance of the movement identified by the method or apparatus. The predefined value may be: 1) set by an agent external to the system (e.g., a caregiver, administrator etc.); and/or 2) calculated using historic movement profile.

The movement sequence may be given a “health risk score” unique for each person. An alert may be sent if the total health risk score, for a given time period, is above, or below, a “threshold” that may be created using one of the following exemplary methods: 1) set by an agent external to the system (e.g., a caregiver, administrator etc.); or 2) calculated using historic movement profile, etc.

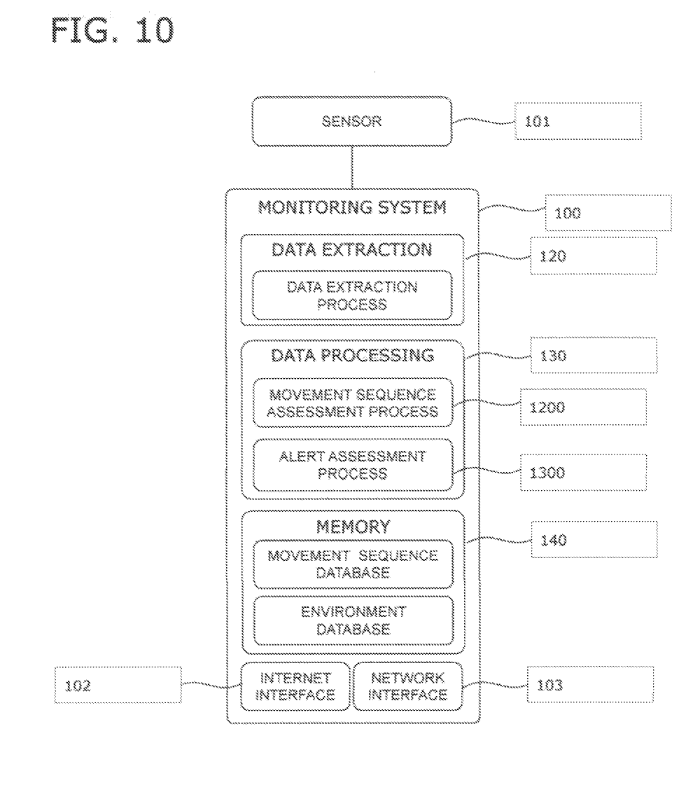

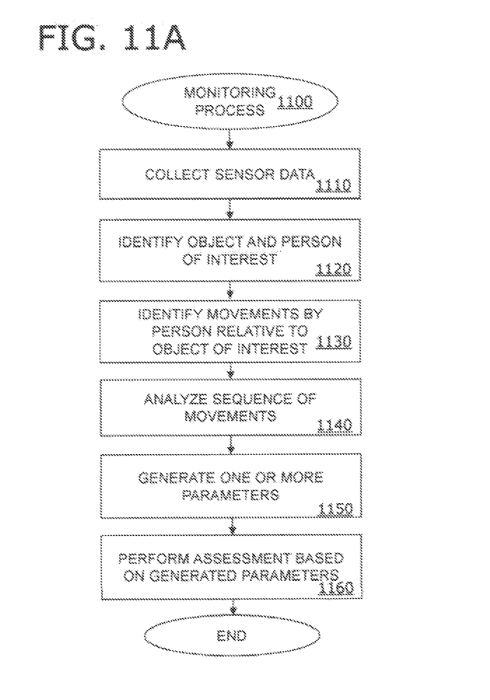

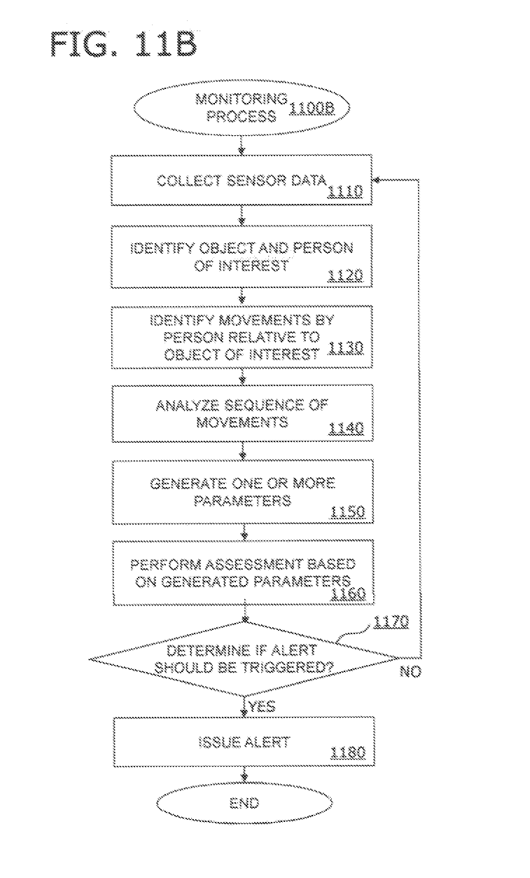

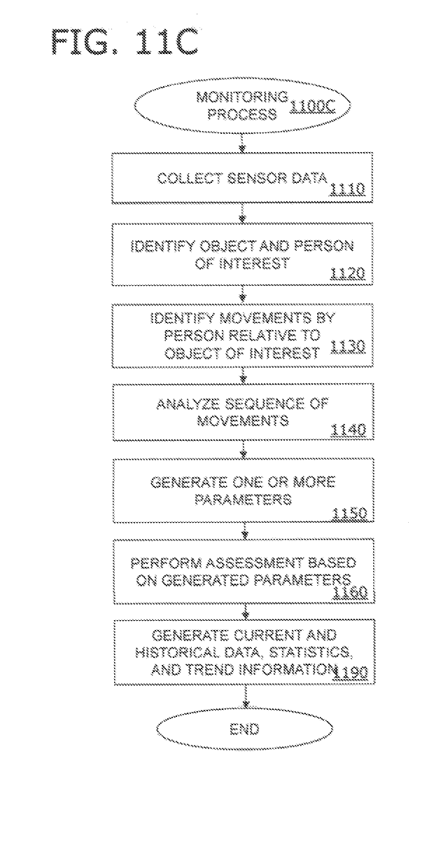

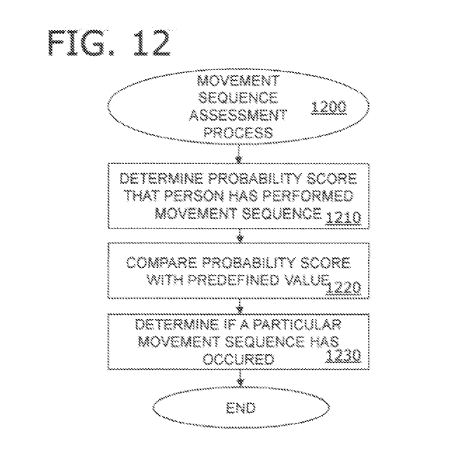

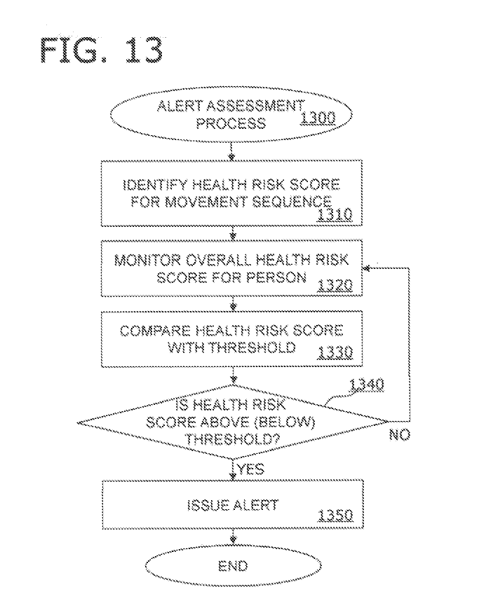

An exemplary embodiment of the present technology is shown in FIG. 10 where an exemplary variation of monitoring system 100 is depicted with exemplary variations of the monitoring process shown in FIGS. 11A-C. In the exemplary variation depicted in FIG. 10, the monitoring system 100 further contains a movement sequence assessment process 1200 (an exemplary variation depicted in further detail in FIG. 12) and an alert assessment process 1300 (an exemplary variation depicted in further detail in FIG. 13).

In FIG. 11A, the monitoring process 1100 depicts how sensor data is collected in step 1110, from which the object and person of interest are identified in step 1120, after which the person's movements vis-à-vis the object of interest are identified in step 1130. At step 1140, the movements are analyzed in order to generate one or more parameters in step 1150, on which subsequently an assessment is performed in step 1160.

In FIG. 11B, an alert process determination, step 1170, is added to the basic FIG. 11A and should the assessment performed in 1160 warrant an alert is issued in step 1180. Another exemplary implementation variation is depicted in FIG. 11C, where the movement information is used to generate current and historical data, statistics, and trends in step 1190.

FIG. 12 illustrates an exemplary embodiment of a variation of the present technology that contains movement sequence assessment process 1200 that in an exemplary variation is contained within step 1140 in FIGS. 11A-C. According to the variation a probability score that the person has performed the movement sequence of interest is calculated in step 1210. In step 1220, the probability score is compared with a predefined value. In step 1230, it is determined if a particular movement sequence has occurred based on comparing the probability score with the predefined value.

FIG. 13 illustrates an exemplary embodiment of a variation of the present technology that contains an alert assessment process 1300. In step 1310, a health risk score is identified for the movement sequence. The health risk score for the specific movement sequence may be set by an external actor, e.g., a caregiver, administrator, or by the system e.g., based on historic movement profile and identification of events that previously have resulted in adverse health events. In step 1320, the overall health risk score is monitored for the person. In step 1330, the overall health risk score is compared with a threshold that may have been set by the external actor or by the system as described above. In step 1340, it is determined if the person is at risk based on the comparison of the health risk score with the threshold. If the comparison indicates that the person is at risk, then an alert is issued in step 1350. If the comparison indicates that the person is not at risk, then the alert assessment process continues to step 1320.

According to an exemplary variation, the present technology senses if a user is about to move out of, or exit, from objects that a person rests or sits on, such as a bed, chair, sofa, other furniture, etc. An alert is sent if the person's position and direction indicates that the person is about to leave the object e.g., move out of, exit, etc.

According to an exemplary variation, the present technology the method enables determination of conditions that put a person at risk for an adverse event by detecting a person's positions relative to environment or objects. The method is robust and works over a broad range of objects where it is important to monitor if a person is about to stand up, exit, or leave an object etc.

The act of leaving the object could be identified using the methods and apparatus of U.S. patent application Ser. No. 13/840,155 as an “adverse” event (i.e. an event which triggers an alarm for a caregiver to follow up on, an event that is stored in memory for further analysis, or an event triggers a signal to another device e.g., a light switch, an oven, a door etc.). The person's relevant positions may be determined by exemplary methods such as looking at posture, one or more limbs of the person, for example as described in U.S. patent application Ser. No. 13/840,155, and others.

That the person is about to exit the bed could be determined by comparing the bed's top 4 corner's 3D coordinates with: the position and, or, movement direction of one or more body parts; or the posture of a person.

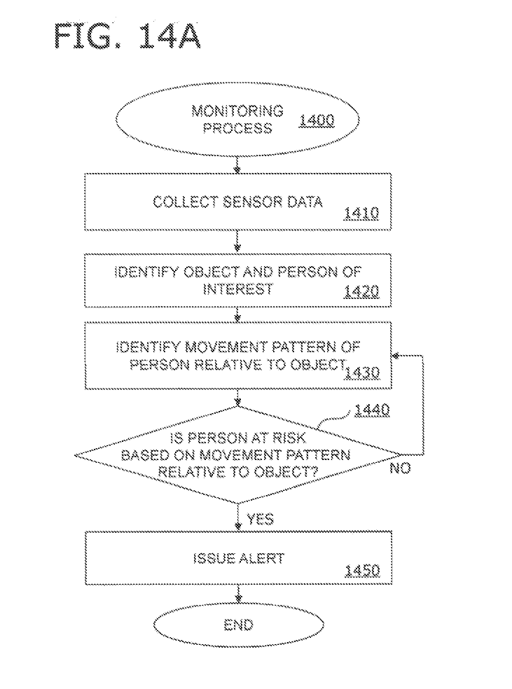

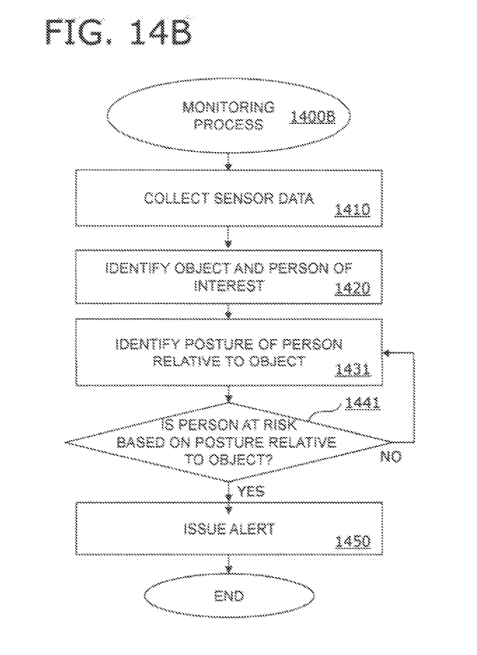

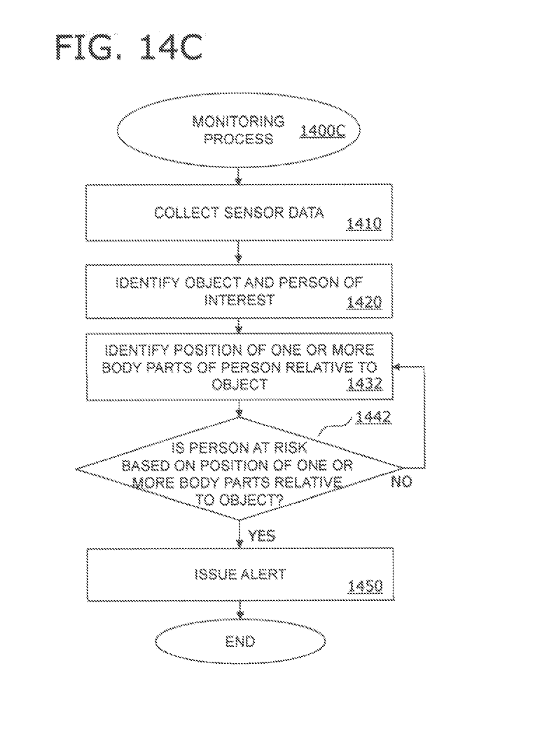

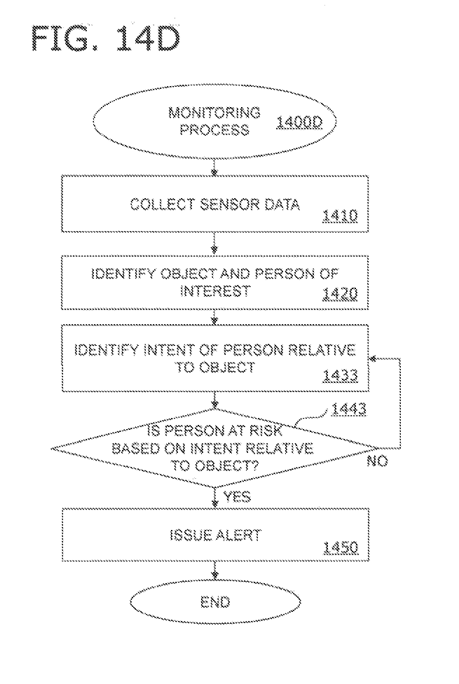

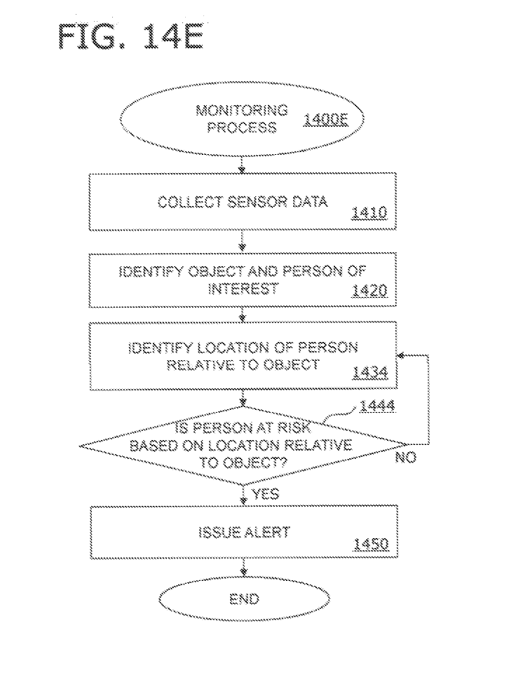

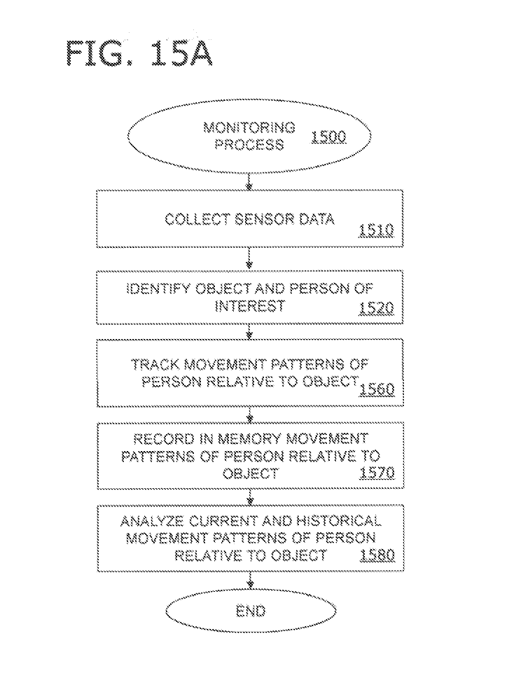

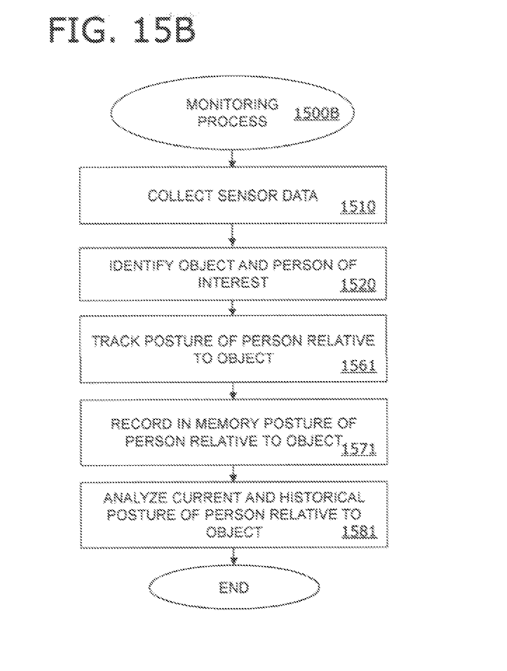

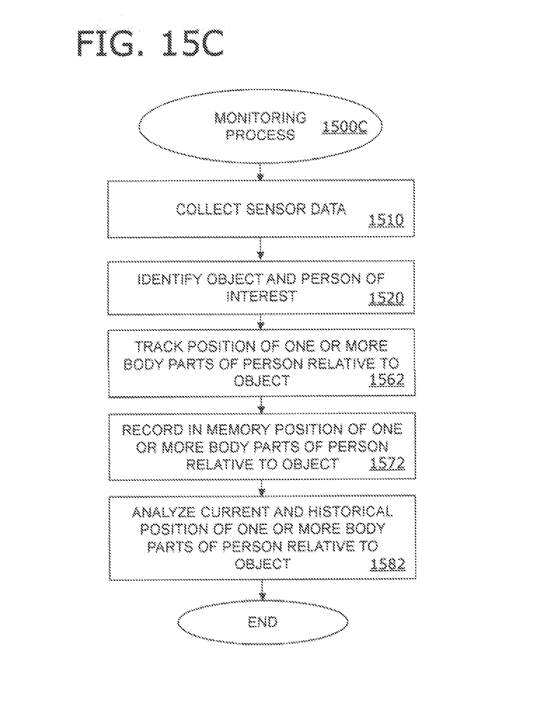

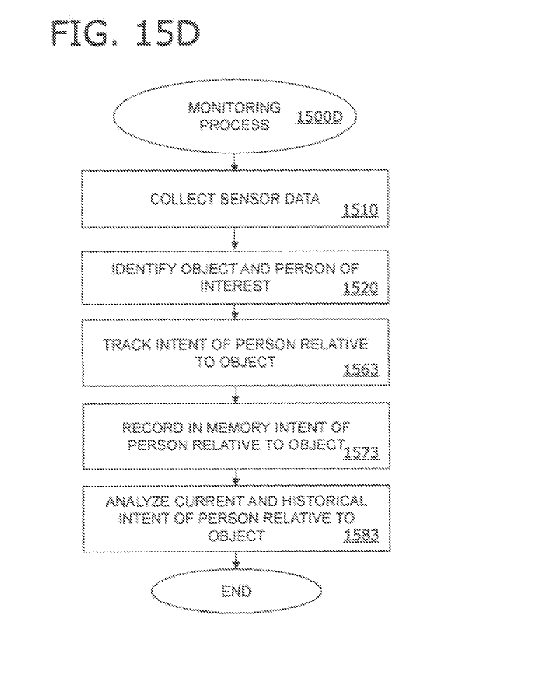

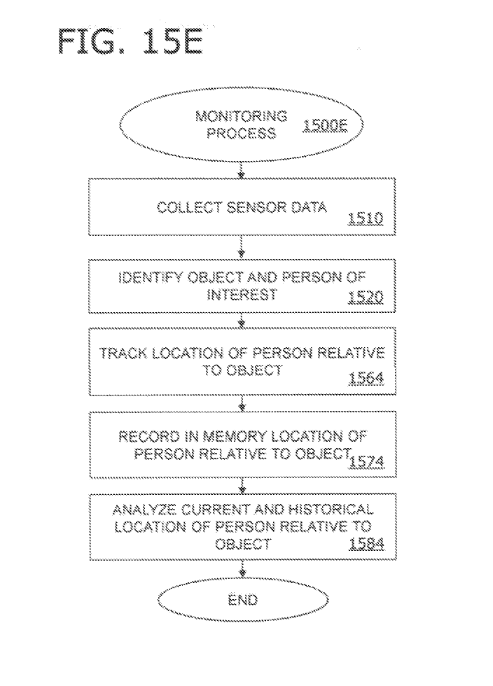

That the person is about to exit the bed may be determined by assessing “intent” through one or a combination of the following exemplary methods: prior personal movement history could be used to build up a person behavior profile that can be used to determine “intent” of getting out of bed; observations of the head (direction, height; if available, eye movements could be further used). Exemplary variations of embodiments of the monitoring process, that may be practiced with the exemplary monitoring system 100 in FIG. 1, are shown in FIGS. 14A-E and described below for exemplary purposes.

In FIG. 14A, the exemplary monitoring process 1400 depicts how sensor data is collected in step 1410, from which the object and person of interest are identified in step 1420, after which the person's movements vis a vis the object of interest are identified in step 1430. In step 1440, an assessment is made of whether the person is at risk based on analysis of the movement patterns of the person in relation to the object of interest. If it is determined that the person is at risk, an alert is issued in step 1450.

FIG. 14B depicts a monitoring process 1400B where the person's posture in relation to the object of interest is identified in step 1431 and an assessment of whether the person is at risk is done in step 1441 using the person's relative postural information.

In FIG. 14C, process 1400C uses information about the position, and/or movements, of one or more body parts of the person relative to the object being first identified in step 1432. Then, the process 1400C makes the at risk assessment in step 1442.

FIG. 14D depicts a process 1400D that shows how a person's “intent” are first identified in step 1433 and then used to make the at risk assessment in step 1443. Exemplary variations for capturing “intent” have been described such as analyzing a person's prior movement history to find movement patterns that typically precede the movement of interest, such as observing head movements, or movement of other limbs etc.

In FIG. 14E, the process 1400E uses information about the location of the person relative to the object, first identified in step 1434, and then the process 1400E proceeds to make the at risk assessment in step 1444.

FIGS. 15A-E show exemplary variations of the monitoring process 1500 that may be practiced with the exemplary monitoring system 100 shown in FIG. 1. FIGS. 15A-E show exemplary variations for how different patterns in movement, posture, position of one or more body parts, intent, or location of person, in relation to object of interest, can be tracked, data recorded and analyzed for current and historical patterns and trends relative to the object.

FIG. 15A depicts how sensor data is collected in step 1510, from which the object and person of interest are identified in step 1520, after which the person's movements vis a vis the object of interest are tracked in step 1560. In step 1570, the movement patterns of the person relative to object are recorded in memory. In step 1580 the current and historical movement patterns of person relative to object are analyzed.

FIG. 15B depicts how the person's posture in relation to the object of interest is tracked in step 1561. In step 1571, the person's posture relative to the object are recorded in memory. In step 1581, the current and historical postural patterns of person relative to object are analyzed.

FIG. 15C depicts how the position of one or more body parts of person in relation to the object of interest is tracked in step 1562. In step 1572, the position of one or more body parts of person in relation to the object of interest are recorded in memory. In step 1582, the current and historical position of one or more body parts of person in relation to the object of interest are analyzed.

FIG. 15D depicts how the intent of the person relative to the object of interest is tracked in step 1563. In step 1573, intent of person relative to the object of interest is recorded in memory. In step 1583, the current and historical intent of the person relative to the object in relation to the object of interest is analyzed.

FIG. 15E depicts how the location of person relative to the object of interest is tracked in step 1564. In step 1574, the location of the person relative to the object of interest is recorded in memory. In step 1584, the current and historical location of person relative to the object in relation to the object of interest is analyzed.

In an exemplary variation of the present technology a robust bed exit alarm uses the combination an optical imager and a thermal imager. Skin temperature is approximately 33 degrees Celsius, much warmer than a climate-controlled room. A thermal imaging camera (typically a two-dimensional array of micro-bolometers) can therefore positively detect whether a person is in a bed without having to rely on information that a person entered the bed. In an exemplary implementation, the method determines if a person is about to exit a bed. However, the method could be generalized to other objects that a person rests or sits on, such as a chair, sofa, other furniture, etc.

In an exemplary embodiment the present technology raises an alarm when a person begins to exit the bed without generating false alarms when a person makes normal movements while sleeping. To accomplish this goal, two or more imagers may be used: an optical imager and a thermal imager. When the person is moving, an optical imager is used to determine some combination of horizontal location, vertical height, orientation, velocity, and time of observation of said body part, or parts. The imager may include a black and white camera, a night vision camera, a color camera, a pair of cameras with depth-from-stereo, a depth camera using structured light, a time-of-flight camera, etc. The image from the camera is analyzed to determine velocity histograms, blob sizes, the location of visible body parts, the relationship between body parts and a bed surface, etc. The factors extracted from the optical imager are used with a heuristic or statistical model to determine when to raise an alarm that the person is attempting to exit the bed. The preferred embodiment uses an IR structured light depth camera because it works when the room is dark and because it reduces the computation required to identify the factors.

The thermal imager detects whether a person is in bed, no matter whether they are moving or still. The thermal imager is used to detect skin temperature, by searching for pixels that have a temperature of approximately 33 degrees Celsius. The thermal image, or points from the thermal image can be re-projected onto the optical image to determine whether the detected skin is within the bed area. When a person has not been detected within the bed using the thermal imager, then bed exit alarms are suppressed. The preferred embodiment uses a low-resolution thermal imaging sensor (e.g. 16, 64 pixels, etc.). Since person pose is determined using the optical imager, a low-resolution thermal imaging sensor is sufficient and reduces cost, processing time, and cooling requirements compared with high-resolution thermal imagers.

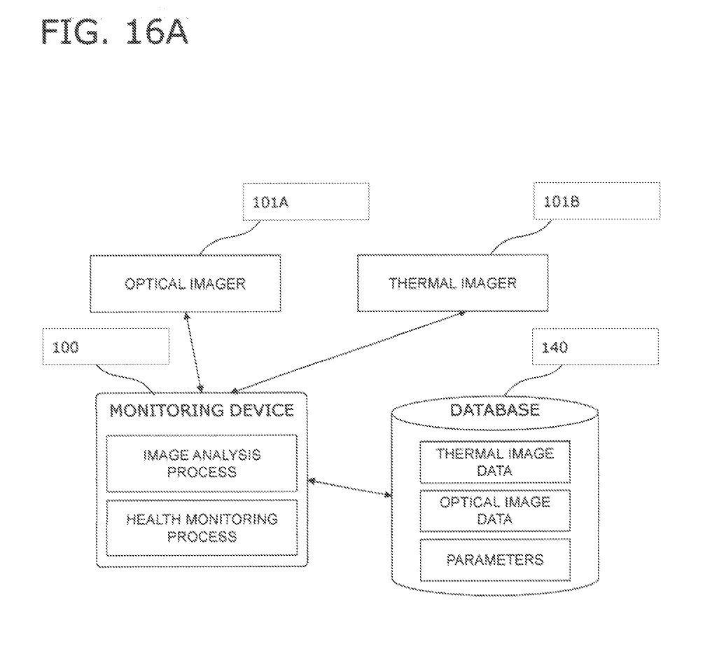

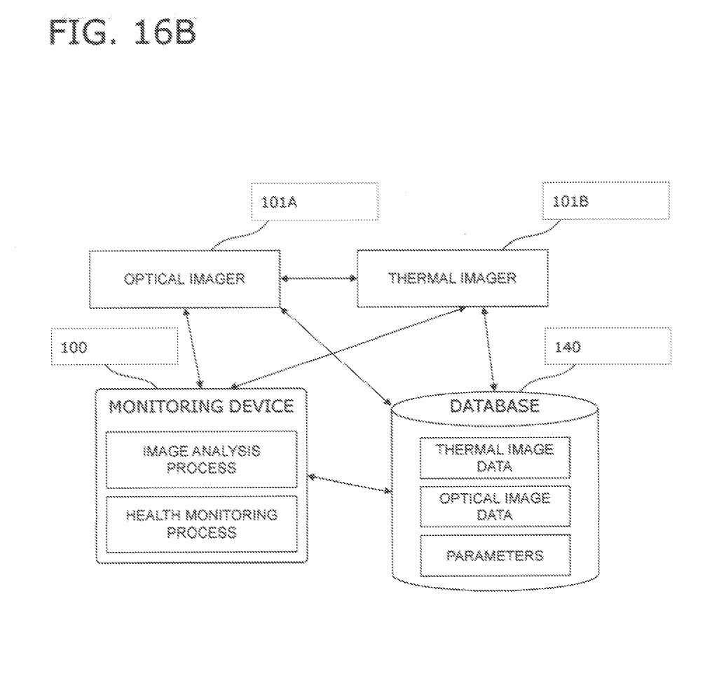

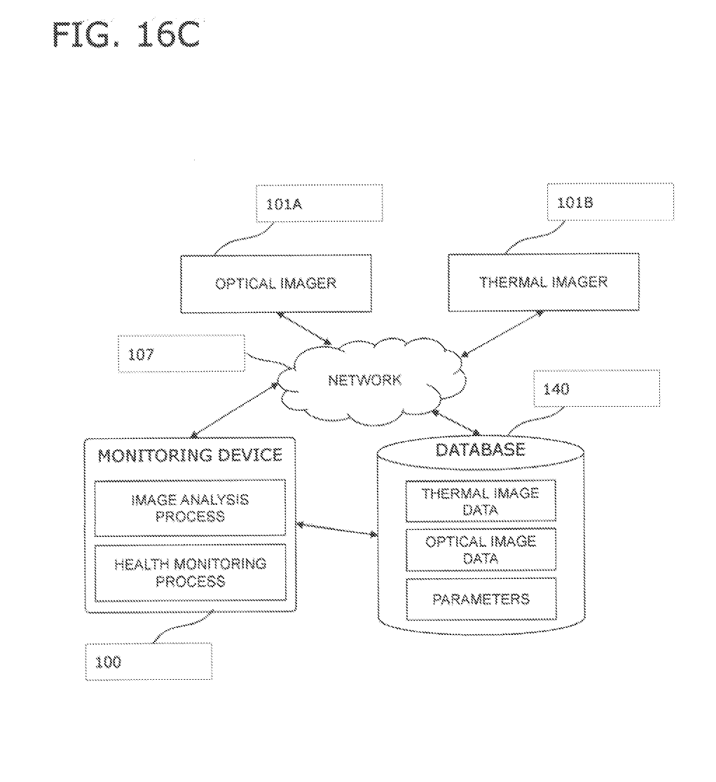

FIGS. 16A-D show exemplary variations of the exemplary monitoring system 100 shown in FIG. 1. In exemplary embodiment FIG. 16A an optical and a thermal imager 101A, 101B are connected to a monitoring device 100 that performs the image analysis and health monitoring processes and stores and retrieves the optical and thermal imaging data as well as other parameters in a database 140.

FIG. 16B shows how different devices may all be linked directly to ensure that there is redundancy to increase robustness. FIG. 16C depicts a network 107, e.g., Internet, Wi-Fi, etc., being used to transmit information between the devices. In FIG. 16D, the system is made more robust by introducing direct data transmission between some of the devices in order to reduce reliance on a network.

According to an exemplary variation of embodiments of the present technology include a foreground/background segmentation step that uses an optical sensor. A model of the background is stored in a memory. The background model may be adapted, as stationary objects are occasionally moved, introduced or removed from the field of view.

In an exemplary implementation the method determines if a person is about to exit a bed. However, the method could be generalized to both 1) other settings in a person's living environment where objects are stationary and moved only occasionally; as well as, 2) other objects that a person rests or sits on, such as a chair, sofa, other furniture, etc.

To reduce the computational effort required to predict or identify bed exit events, the present technology segments each video frame into a foreground and a background. The foreground is analyzed to determine whether a bed exit event is occurring or is likely to occur, while the background can be ignored. The background is assumed to consist of inanimate objects that are usually stationary. The bed exit detector makes use of this assumption to persist a model of the background over time. The input video is compared against the model. Pixels, neighborhoods or regions of the video are classified as background if they are consistent with a background model or inconsistent with a foreground model. The video may additionally be compared to a foreground model. Consistency with the background model can be determined by comparing color, brightness, depth, texture, etc. The background model can be a simple snapshot of an empty room, a statistical distribution of values for each pixel, etc. A foreground model typically includes information expected for foreground objects e.g. continuity, size, shape etc.

The background in a bedroom occasionally changes. For example, a person may place a glass of water on a nightstand. They may leave a wheel chair in the room. Such changes are initially classified as foreground. These scene changes build up over time and erode the benefit of foreground/background segmentation. Since these objects are stationary, it is desirable to incorporate them into the background model. One way to do this is to segment the foreground into a discrete set of connected components. If a component is too small, too large, too hollow, etc., to represent a person, then it is it can be assumed that it should be considered part of the background. The patch of the background model corresponding to the component can be simply replaced with the new color, brightness, depth, texture, etc. Another way to update the background model is to derive the background model for each pixel from a sliding window of input frames. When a stationary object is introduced to the field of view, the distribution for each pixel of the object will eventually converge to the new value.

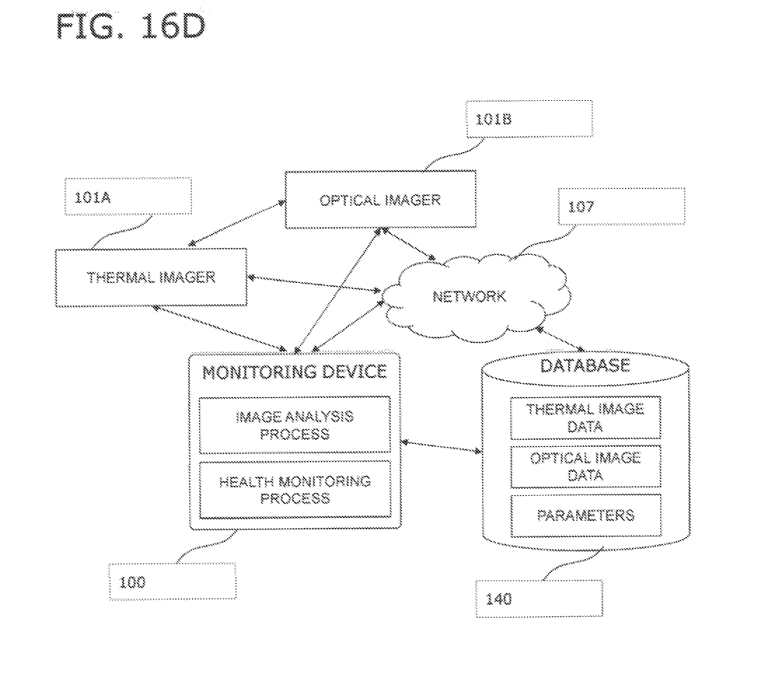

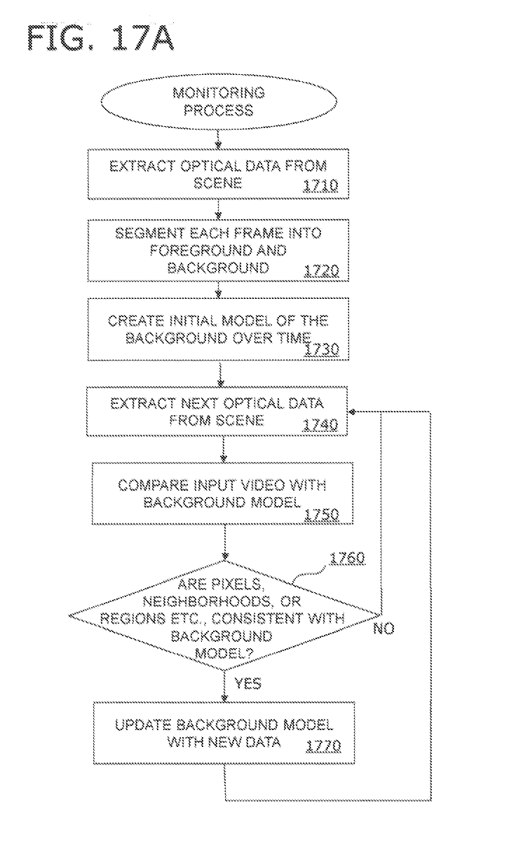

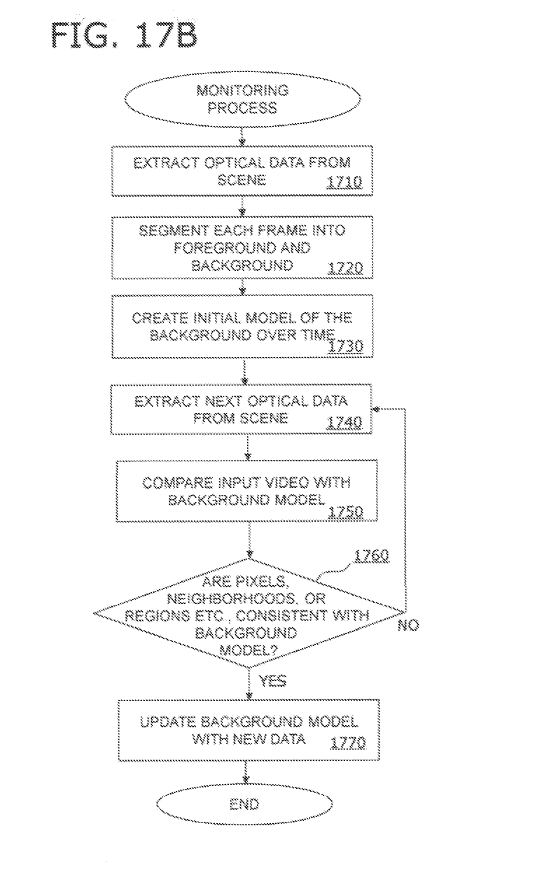

FIGS. 17A and 17B show exemplary variations of the monitoring process that may be practiced with the exemplary monitoring system 100 shown in FIG. 1. The monitoring processes 1700, 1700B, respectively, begin with step 1710 where optical data is extracted from the scene, followed by segmentation of each frame into background and foreground data in step 1720. In step 1730, an initial model of the background is constructed over time. In step 1740, new optical data is extracted from the scene that is then compared in step 1750 where input video is compared with the background model. In step 1760, the new data are analyzed for consistency with the background, e.g. pixels, neighborhoods, or regions etc. If it is determined in step 1760 that the data is not consistent then the process returns to step 1740. If, on the other hand, it is determined in step 1760 that the data is consistent then the background model is updated with this data in step 1770 after which the process in FIG. 17A returns to step 1740 to collect further data from the scene. In FIG. 17B the process ends after the background model has been updated.

### INCORPORATION BY REFERENCE

All patents, published patent applications and other references disclosed herein are hereby expressly incorporated in their entireties by reference.

It will be appreciated by those of ordinary skill in the pertinent art that the functions of several elements may, in alternative embodiments, be carried out by fewer elements, or a single element. Similarly, in some embodiments, any functional element may perform fewer, or different, operations than those described with respect to the illustrated embodiment. Also, functional elements (e.g., modules, databases, interfaces, computers, servers and the like) shown as distinct for purposes of illustration may be incorporated within other functional elements in a particular implementation.

While the subject technology has been described with respect to preferred embodiments, those skilled in the art will readily appreciate that various changes and/or modifications can be made to the subject technology without departing from the spirit or scope of the invention as defined by the appended claims.

What is claimed is:

1. A process for detecting and predicting events occurring to a person, comprising:
observing, using a sensor, a plurality of readings of a parameter of the person, wherein the parameter is one of: horizontal location, vertical height, and time of observation;
storing the readings in a computer memory;
determining, by a processor, a pattern of behavior based on the readings;
storing a pattern of interest based on the readings;
identifying from the readings the pattern of interest;
distinguishing a person that exhibits the pattern of interest, from other people or animate objects;
labeling the person with a unique identifying label;
linking data captured about the person with the identifying label;
determining conditions under which a subset of the readings correspond to an occurrence of an event; and
detecting when the subset of readings corresponds to the occurrence of the event.

2. The process of claim 1, wherein observing the readings further comprises: sensing the parameter with respect to a combination of two or more of the person's body parts selected from the group consisting of a head, a torso, a limb, and combinations thereof.

3. The process of claim 1, wherein observing the readings further comprises: sensing the parameter with respect to one body part selected from the group consisting of a head, a torso, and a limb.

4. The process of claim 1, wherein said detecting further comprises producing an electronic signal that controls another device that has an electronic control and storing readings corresponding to the event in memory for later retrieval and analysis.

5. The process of claim 1, wherein the pattern of interest is exhibited by person's way of moving in general.

6. The process of claim 1, wherein pattern of interest is exhibited by person way of moving in a specific location.

7. The process of claim 1, wherein pattern of interest is exhibited by a person moving next to, or around, a specific object or a person using a specific object.

8. The process of claim 1, wherein pattern of interest is a result, or an intrinsic part, of a person body characteristic.

9. The process of claim 1, wherein said labeling further comprises that no personal identifying information for the person is either captured or stored.

10. The process of claim 1, wherein determining conditions under which the readings correspond to the occurrence of an event is done by comparison to a threshold, application of a conditional rule, or application of a statistical test.

11. The process of claim 1, wherein determining conditions under which the received reading correspond to the occurrence of an event is done by an agent external to the system.

12. The process of claim 1, wherein determining conditions under which the received reading correspond to the occurrence of an event is done by the system based on historic movement profile through identification of an event that has previously resulted in an adverse health incident or other incident of interest.

13. The process of claim 1, wherein said detecting further comprises detecting a change in behavior and identifying from the change in behavior a combination of one or more readings corresponding to an abnormal event.

14. The process of claim 1, wherein determining the pattern of interest is done from the historic movement profile of the person.

15. The process of claim 1, wherein determining the pattern of interest based on the readings is done through use of behavior templates for such behavior that are created by an agent external to the system or created by recording the behavior by the person, by a different set of users, or by one or more actors.

16. The process of claim 1, wherein observing, using a sensor, a reading of a parameter of the person, or a body part of the person, includes velocity.

17. The process of claim 1, wherein observing, using a sensor, a reading of a parameter of the person, or a body part of the person, includes orientation.

18. The process of claim 1, wherein observing, using a sensor, a reading of a parameter of the person, or a body part of the person, includes velocity and orientation.

19. The process of claim 1, wherein determining, by a processor, a pattern of behavior based on the readings further comprises that the processor in a training mode identifies and stores a pattern for normal behavior or a pattern of interest.

20. The process of claim 1, wherein the user, for which the process is detecting and predicting events, is an animate object.

21. A computing machine for detecting and predicting an event based on changes in behavior of a person comprising:
a computer memory;
a sensor; and
a computer processor in communication with the computer memory and the sensor, wherein
the computer processor executes a sequence of instructions stored in the computer memory, including instructions for:
observing, using a sensor, a plurality of readings of a parameter of the person, wherein the parameter is one of: horizontal location, vertical height, and time of observation;
storing the readings in a computer memory;
determining, by a processor, a pattern of behavior based on the readings;
storing a pattern of interest based on the readings;
identifying from the readings the pattern of interest;
distinguishing a person that exhibits the pattern of interest, from other people or animate objects;
labeling a person that exhibits the pattern of interest with an unique identifying label;
linking data captured about the person with the identifying label;
determining conditions under which a subset of the readings correspond to an occurrence of an event; and
detecting when the subset of readings corresponds to the occurrence of the event.
